(19) United States
(12) Patent Application Publication
(10) Pub. No.: US 2022/0212462 A1
(43) Pub. Date: Jul. 7, 2022

(54) SYSTEMS AND METHODS FOR DIRECT TO GARMENT PRINTING

(71) Applicant: 240 Tech LLC, Santa Ana, CA (US)

(72) Inventors: Kris Otto Friedrich, La Quinta, CA (US); Blair Kristine Dorsey, San Juan Capistrano, CA (US); Alex Phelan, Costa Mesa, CA (US); Kenny Lee, Whittier, CA (US)

(21) Appl. No.: 17/595,037

(22) PCT Filed: May 5, 2020
(86) PCT No.: PCT/US20/31505

§ 371 Date: Nov. 5, 2021

Related U.S. Application Data
(60) Provisional application No. 62/844,018, filed on May 6, 2019.
(60) Provisional application No. 62/878,234, filed on Jul. 24, 2019.

(51) Int. Cl. B41F 15/36; B41F 15/10; B41J 3/407

(52) U.S. Cl. CPC B41F 15/36; B41J 3/4078; B41F 15/10

(57) ABSTRACT

A high-speed, closed-loop fabric printer apparatus is provided, comprising a plurality of consecutive stations that can be managed by a single operator. In particular, shirts or other fabric garments may be individually loaded and secured on a pallet by an operator, and the loaded pallets may then cycle through a plurality of unmanned stations positioned along a contiguous path (e.g., oval). The pallet may be configured to expose a main print area and a neck tag area, to allow for both areas to be printed. The pallet may include a neck tag print plate that may elevate the neck tag area to be at the same level as the main print area. In some embodiments, a top coat printing station may apply a top coat to the main print area and/or neck tag area.

### CROSS-REFERENCE TO RELATED APPLICATIONS

This application claims the priority and benefit of U.S. Provisional Application No. 62/844,018 filed on May 6, 2019, U.S. Provisional Application No. 62/878,234 filed on Jul. 24, 2019, and International App. No. PCT/US2020/031505 the entire contents of which are each incorporated herein by reference.

### TECHNICAL FIELD

The present disclosure relates generally to fabric printing, and, more particularly, to high-turnaround, closed-loop, direct to garment printing.

### BACKGROUND OF THE INVENTION

Screen printing or “silk-screening” is a printing technique that has been around for centuries in which a mesh is used to transfer ink onto a substrate (e.g., paper or fabric), except in areas made impermeable to the ink by a blocking stencil. Typically, a blade or squeegee is moved across the screen to fill the open mesh apertures with ink and press the screen onto the substrate, such that the ink wets the substrate where not blocked by the stencil, leaving the ink behind when the screen is removed from the substrate. One color (or a single mixture of colors) is printed at a time so that several screens can be used to produce a multicolored image or design.

Enhancements to silk-screening have occurred over time, such as rotary multi-screen manual systems, automated silk-screening assembly lines, continuous rotating cylinder printing, and others (e.g., heat transfer vinyl (HTV) or transfer printing). However, more recent advancements in technology have adapted inkjet printing for fabrics (e.g., tee shirts), allowing for greater flexibility in design and processing. For example, colorful pictures and intricate patterns can easily be created and transferred to a fabric surface in high resolution through computerized ink jets with various colored inks in a process typically referred to in the art as “direct to garment” (DTG) inkjet printing. However, inkjet printing on fabrics still presents various issues, and there remains room for improvement in terms of image quality and production speed.

### SUMMARY OF THE INVENTION

The techniques described herein relate generally to high-turnaround, closed-loop, direct to garment (DTG) printing. Specifically, according to one or more embodiments of the present disclosure, a high-speed, closed-loop (e.g., oval) fabric printer comprises a plurality of consecutive stations that can be managed by a single operator and is capable of producing as many as 300 printed shirts per hour. In particular, shirts or other fabric garments may be individually loaded and secured on a pallet by an operator, and the loaded pallets may then cycle through a plurality of unmanned stations positioned along a contiguous path (e.g., oval). The stations may be configured for pretreating the fabric surface, drying and pressing the pretreated fabric with heat, and then inkjet printing a selected image, among others. In this manner, a “wet-to-dry-to-wet” DTG printing process may thus be achieved, along with optimal controls described herein for maximum adaptability. Furthermore, due to the closed-loop design, a recently printed fabric product returns to the operator to be unloaded at the same or adjacent position in which a new unprinted fabric is loaded, allowing for increased throughput and minimal operator requirements.

The printing systems and methods provided herein may permit simplified and more rapid neck tag printing. Pallet assemblies are provided that may allow high quality neck tag printing. The systems and methods provided herein may further provide a top coat that is printed on a garment, which may improve durability of ink that is applied to the garment.

An aspect of the invention is directed to a pallet assembly for direct-to-garment printing, comprising: a main print plate configured to accept a garment; a clamshell comprising one or more open areas and configured to rotate relative to the main print plate between (1) an open position in which the garment may be loaded onto the main print plate or unloaded from the main print plate, and (2) a closed position that secures the garment to the main print plate; and a neck print plate coupled to the clamshell and configured to rotate relative to the clamshell.

Further aspects of the invention are directed to a method of direct-to-garment printing, said method comprising: providing a pallet assembly comprising: a main print plate configured to accept a garment; a clamshell comprising an open area and configured to rotate relative to the main print plate between (1) an open position in which the garment may be loaded onto the main print plate or unloaded from the main print plate, and (2) a closed position that secures the garment to the main print plate; and a neck print plate coupled to the clamshell and configured to rotate relative to the clamshell; and loading a garment over the main print plate of the pallet assembly.

Additional aspects of the invention may be directed to a method for direct-to-garment printing, said method comprising: applying, with aid of a color printing apparatus comprising one or more color print nozzles, color ink over the layer of white ink on a garment supported by a pallet assembly; moving the pallet assembly with the garment supported thereon to a top coat printing apparatus; and applying, with aid of the top coat printing apparatus comprising one or more top coat print nozzles, a top coat over the color ink applied to the garment, wherein the top coat comprises a solution that improves durability of the white ink and the color ink applied to the garment.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an overhead view of an apparatus for high-turnaround, closed-loop, direct to garment printing;

FIGS. 2-5 are side views of an apparatus for high-turnaround, closed-loop, direct to garment printing;

FIG. 6 is a perspective view of an apparatus for high-turnaround, closed-loop, direct to garment printing;

FIG. 7 is an example simplified view of a printer stage of an apparatus for high-turnaround, closed-loop, direct to garment printing;

FIG. 8 is an example garment on a pallet of an apparatus for high-turnaround, closed-loop, direct to garment printing;

FIGS. 9 and 10 are an example simplified view of stages of an apparatus for high-turnaround, closed-loop, direct to garment printing;

FIG. 11 shows an example simplified procedure for direct to garment printing; and

FIG. 12 shows an example of a neck tag pallet to allow direct to garment printing for the neck tag;

FIG. 13 shows an example of a clamshell of a pallet assembly in an open position;

FIG. 14 shows an example of a clamshell of a pallet assembly in a closed position with a neck print plate in a down position;

FIG. 15 shows an example of a clamshell of a pallet assembly in a closed position with a neck print plate in an upward position;

FIG. 16 shows an example of an apparatus for closed-loop, direct to garment printing, including at least one digital pretreatment station, and at least one print station;

FIG. 17 shows an exemplary pallet assembly with an open clamshell;

FIG. 18 shows an exemplary pallet assembly with a closed clamshell and a neck print plate in a down position;

FIG. 19 shows an exemplary pallet assembly with a closed clamshell and a neck print plate in an upward position;

FIG. 20 shows a close-up view of an exemplary neck print plate;

FIG. 21 shows a close-up view of an opening in the pallet assembly configured to expose a neck tag region;

FIG. 22 shows an upper view exemplary pallet assembly supported by an arm;

FIG. 23 shows a lower view of an exemplary pallet assembly supported by an arm;

FIG. 24 shows a close-up of a lower view of an exemplary pallet assembly;

FIG. 25 shows a close-up of a side feature of an exemplary pallet assembly;

FIG. 26 shows a lower side feature of an exemplary pallet assembly supported by an arm;

FIG. 27 shows a top view of a closed-loop, direct to garment printing apparatus;

FIG. 28 shows a side view of a closed-loop, direct to garment printing apparatus;

FIG. 29 shows a perspective view of a closed-loop, direct to garment printing apparatus;

FIG. 30 shows an example of a closed-loop, direct to garment printing apparatus that employs a top coat printing station;

FIG. 31 shows an example of a garment with one or more layers of solution applied thereon;

FIG. 32 shows an additional view of a closed-loop, direct to garment printing apparatus that employs a top coat printing station;

FIG. 33 shows an additional view of a closed-loop, direct to garment printing apparatus that employs a top coat printing station; and

FIG. 34 shows an additional view of a closed-loop, direct to garment printing apparatus that employs a top coat printing station.

### DETAILED DESCRIPTION OF THE INVENTION

The invention provides systems and methods for high-turnaround, closed-loop, direct to garment (DTG) printing. Systems and methods are provided for improved neck tag printing. Top coat printing systems may be provided to improve durability of ink printed on garments. Various aspects of the invention described herein may be applied to any of the particular applications set forth below. The invention may be applied as a part of a fabric production system. It shall be understood that different aspects of the invention can be appreciated individually, collectively or in combination with each other.

As mentioned above, recent technological improvements have adapted DTG printing to print very high quality, full color, photographic prints on just about any textile substrate (e.g., fabrics, canvas, tee shirts, etc.). However, inkjet printing on fabrics is still limited with regard to resolution and throughput, especially in combination.

For instance, DTG printing techniques often require pretreating the substrate, particularly darker colored fabrics, with a chemical primer solution in order to achieve consistent and even printing. Proper application of the pre-treatment solution helps to obtain optimum absorption levels and ink adhesion to the fabric while also minimizing lateral bleeding, which may impact color, opacity, definition, and intensity.

Currently, pretreating techniques falls into two categories, referred to comparatively herein as “wet-on-dry” (WD) and “wet-on-wet” (WW). In wet-on-dry systems, the substrate is first pretreated either manually or by a pretreatment machine, and then dried, typically manually using a dryer and/or heat press. Later, the already pretreated (and dried) substrate is placed into the DTG printer for image printing with inks (hence “wet-on-dry”). In wet-on-wet systems, on the other hand, a printer typically first applies (e.g., by spraying) a pretreatment solution onto the substrate (“wet”), and then quickly (i.e., before it has a chance to dry) inkjet prints (“wet”) the colored image onto the wet substrate. Wet-on-wet systems are generally fully integrated direct in-line processes, where an operator inserts an untreated garment, and then the pretreating and ink printing occur one after another within the same DTG printer. Notably, in both systems (WD and WW), it is common to first print a layer of white as a base layer upon which the colored image may then be printed.

Wet-on-dry systems are a multi-step process requiring time for drying between multiple stages of operation, often needing multiple workers or dividing a worker's time among different machines). WD systems generally also require storage of pretreated (and dried) garments and typically have a generically pretreated area on the garment (e.g., a full rectangle of “printable” area) regardless of the actual image to be printed. On the other hand, wet-on-wet systems may only be single-step processes (one worker inserting an untreated garment into the printer and removing a completed product). However, WW processes require very careful chemical coordination between the pretreat solution and ink and may still result in the two applications mixing together and smearing the printed image. Both systems also are designed for minimal production runs (e.g., typically up to 100 or so garments per customer order), since the DTG printers in both systems are only configured to print one (up to four) garments at a time (i.e., a worker places a garment in the printer, waits for it to print, removes the garment from the printer, inserts a new garment into the printer, waits for that garment to print, and so on).

The techniques described herein alleviate the concerns mentioned above, providing high-turnaround, closed-loop, DTG printing. Specifically, according to one or more embodiments as described in greater detail below, a high-speed, closed-loop (e.g., oval) fabric printer comprises a plurality of consecutive stations that can be managed by a single operator. As detailed below, fabric substrates, such as shirts or other fabric garments, may be individually loaded and secured on a pallet by the operator, and the loaded pallets then cycle through a plurality of unmanned stations positioned along a contiguous path. The stations may be configured for pretreating the fabric surface, drying and pressing the pretreated fabric with heat, and then inkjet printing a selected image, among others demonstrated further herein. In this manner, a newly established “wet-to-dry-to-wet” DTG printing process may thus be achieved. Due to the closed-loop design of the contiguous path (illustratively oval, although other options are also possible), a recently printed fabric product returns to the operator to be unloaded at the same or directly adjacent position in which a new unprinted fabric substrate (e.g., garment) is loaded, allowing for increased throughput and minimal operator requirements (e.g., single operator operation). The techniques herein also provide for optimal controls and coordination between the stages of the system, allowing for maximum adaptability (e.g., for ink compositions, fabric materials, fabric thicknesses, image resolutions, and so on).

The systems and methods provided herein may also allow for quick and easy loading of garments that may include a neck tag area. The systems and methods provided herein may allow the neck tag area to be treated and printed simultaneously with a main print area of the garment, such as a front of the garment. This may include pretreatment and/or top coating of the main print area and the neck tag area. For instance, a pallet assembly may be provided that may secure the garment in a manner that allows for digital printing of the neck tag area with the main area of the garment, without requiring modification of one or more stations. The stations may advantageously operate as previously provided without requiring any or substantial modification in order to allow the neck tag area to be printed.

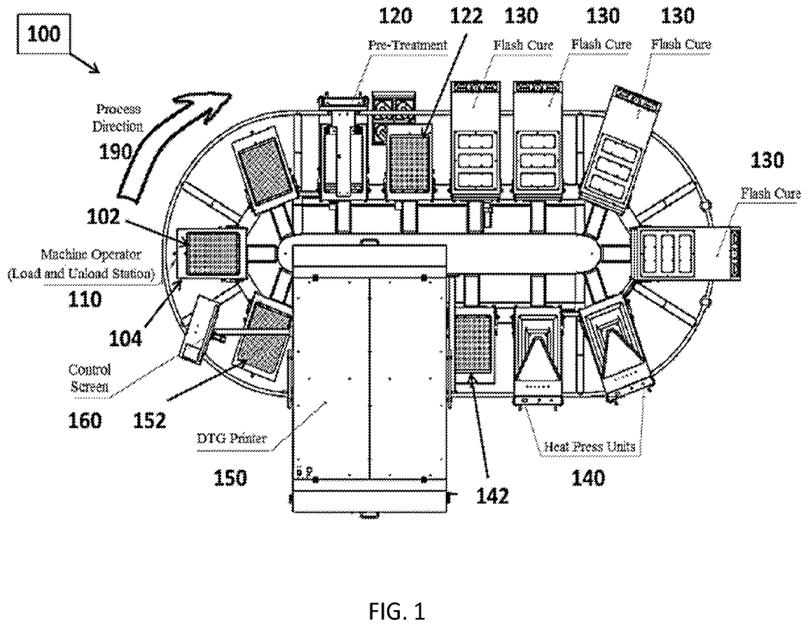

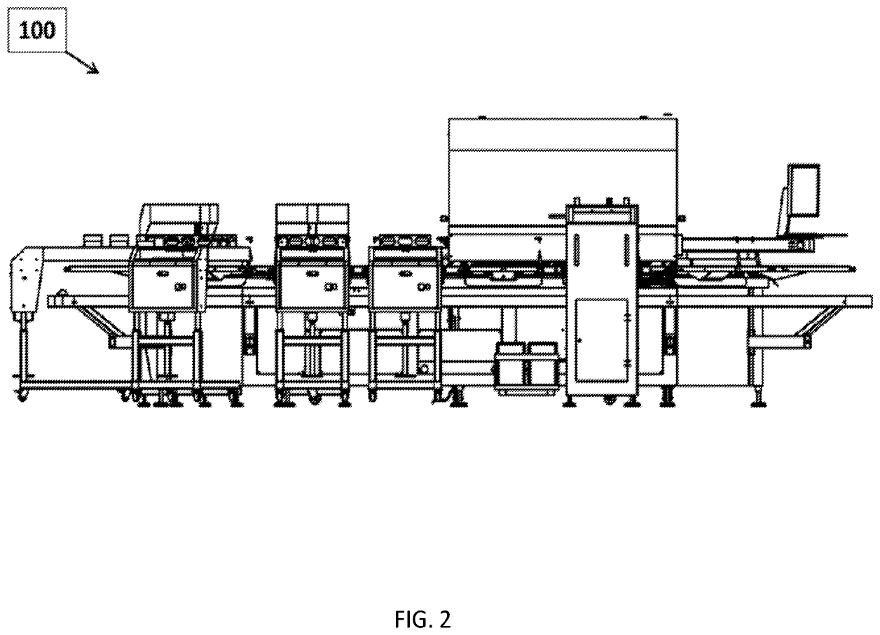

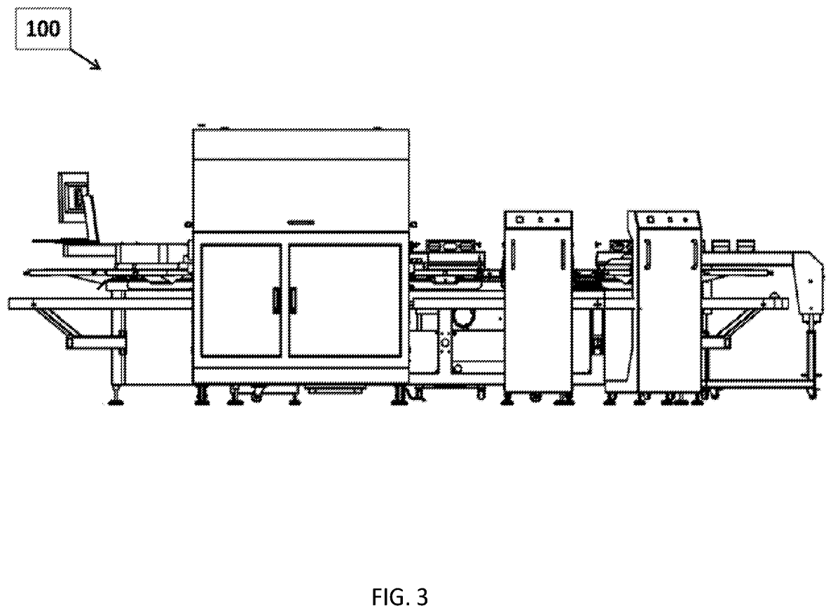

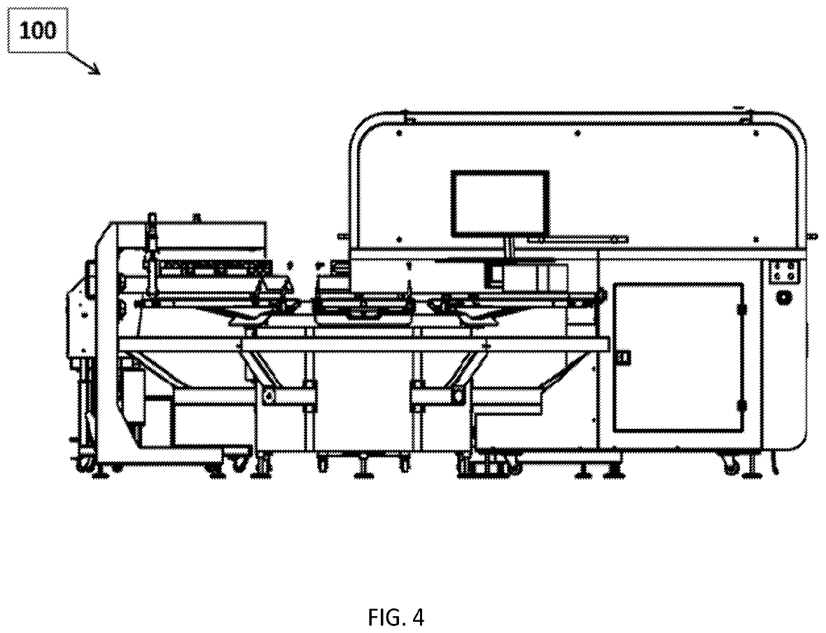

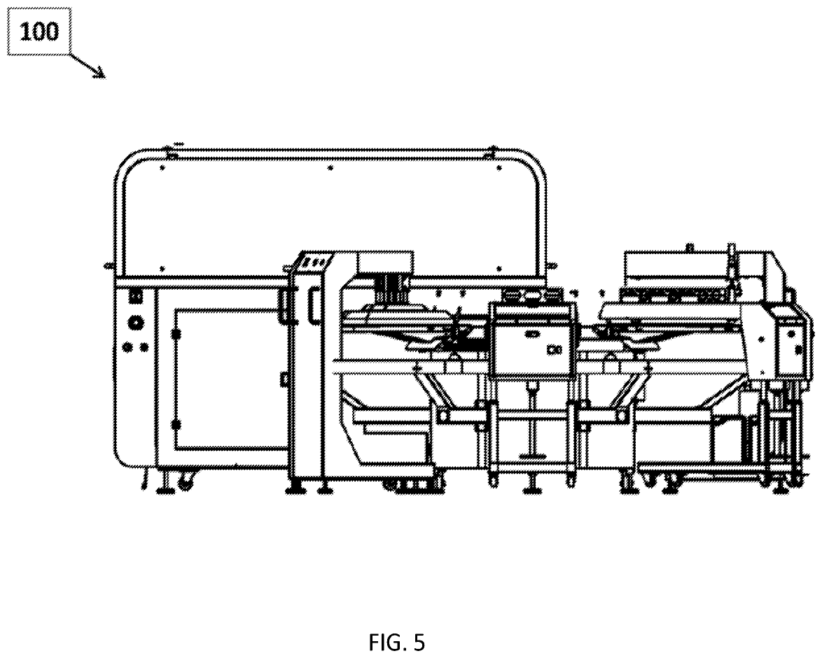

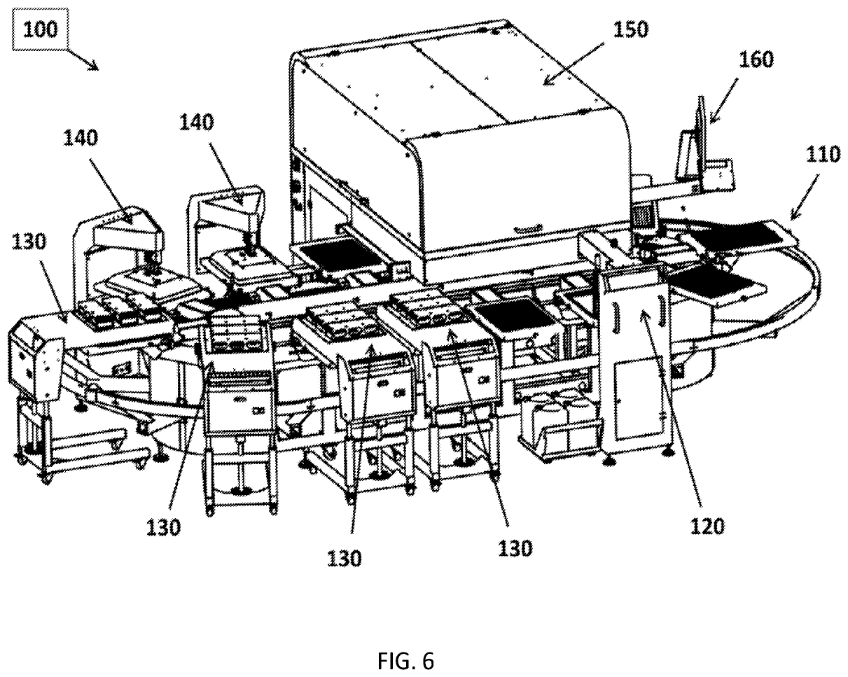

Reference is made generally to FIGS. 1-21 below, illustrating example embodiments of high-turnaround, closed-loop, direct to garment printing in accordance with various aspects of the techniques herein.

In general, as shown, a single operator can both load untreated fabric substrates (e.g., garments) into the printing machine and unload printed garment products from the machine. Since the process is a continuously operating loop, pallets move between sequential stations, stopping at each for a preset period of time. Illustratively, the pallets move in tandem and the distance between consecutive stations is generally the same, such that the garment “sits” at each station for the same amount of time. Generally, the dwell time at each process station may be dictated by a rate-limiting step of the overall process. However, this may not always be the most time-consuming step of the printing process, which is typically drying a treated/printed fabric. For example, the time spent at each station may generally be set by the amount of time needed to print the image on the garment, since increased need for drying time can be managed by increasing the number of drying stations positioned along the path, as discussed below.

The overall process begins with choosing a specific design for a final printed image, its features (e.g., colors, resolution, size, etc.), and a type of fabric garment on which the image is to be printed. These together typically dictate printing conditions (such as number of print passes, number and type of print heads, ink composition, pretreating conditions, etc.), which determine both the overall printing rate and the speed at which the garment passes through each station. Note that in certain embodiments, this may also affect the cost for the batch of final printed garments, as thicker fabrics or higher quality images will generally require more processing time and thus less of a throughput. For example, the garment may be made of a variety of different types of fabrics, such as cotton or synthetics, and may also vary in thickness and in size. Larger, thicker garments may require greater loading times, printing times, and/or drying times. In addition, the desired printed image, such as the image design, image size, color scheme, and the target location on the garment, may also impact the overall process time and the time spent within each process station. Note that pallet design may also be modified as needed for certain types of garments in order to improve overall process efficiencies.

Selected image details and printing conditions are programmed into a color printer, and a printing time is established. From this, the number and types of process stations along the continuous oval process loop can be determined, and each process station can be programmed to achieve a desired result within the established preset process station time, as described below. Once the printer is programmed, the dwell time in the stations is set, and the process stations are positioned, the overall continuous printing process can begin.

In some instances, a pretreatment printer may be programmed along with an image printer (e.g., white and/or color printer). The pretreatment printer may receive similar image information as an image printer. In another embodiment, when an image printer is programmed, a pretreatment printer may automatically receive the same or similar data, which may allow the pretreatment printer to determine a pattern to print.

Similarly, a top coat printer may be programmed along with the image printer and/or pretreatment printer. The top coat printer may receive similar image information as the image printer and/or pretreatment printer. When an image printer or pretreatment printer is programmed, a top coat printer may automatically receive the same or similar data, which may allow the top coat printer to determine a pattern to print.

With reference to FIGS. 1-6, printing apparatus 100 comprises a plurality of pallets that are movable through a plurality of stations. The pallets stop at each station for the determined dwell time. In particular, at operator station 110, an operator may load fabric substrate 102 (e.g., a garment, such as a t-shirt or sweatshirt) onto pallet 104 and secures it into place (such as by lowering a pallet frame onto the garment and latching it into position). The garment is positioned so that the surface onto which the image is to be printed is face up, thereby providing a window to access the printable surface. As a specific example, a shirt can be loaded, with the neck facing the operator stationed along the outside of the oval track. Smoothing of the printable surface can also occur, either automatically or manually by the operator, prior to securing the fabric in place. The loading of the garment may include exposing a neck tag print area of the garment. The neck tag print area may positioned to provide a window to access the printable neck tag area. The neck tag print area may be co-planar with a main print area. The shirt is loaded and secured at the operator station within the established process station time (the dwell time).

The resulting loaded pallet then passes, as shown by process direction arrow 190, from operator station 110 to one or more pretreatment stations 120. Once stopped at this station, another shirt may be loaded by the operator onto a subsequent empty pallet at operator station 110. At pretreatment station 120, a pretreatment fluid (e.g., a pretreatment solution, such as an acidic pretreatment) can be applied to the target printable surface as needed. The amount of pretreatment, type of solution, and method of application can be varied depending, for example, on the type of garment, the type and color of fabric, and the image design. For example, for a white or light colored cotton tee shirt, no pretreatment may be needed, depending on ink compositions and fabric type, but for darker colors or thicker fabrics, pretreatment may be preferred. In some embodiments, pretreatment occurs using a nozzle sprayer to apply an acidic pretreatment solution to the printable surface. Alternatively, the acidic pretreatment solution may be applied using a screen printing techniques. However, nozzle spraying may be preferred since screening methods generally require refilling of the solution reservoirs after application, which would necessitate the addition of another operator or at least would require attention from the loading/unloading operator. In addition, nozzle spray printing enables targeting of specific portions of the printable surface so that only the areas that require pretreatment (e.g., the areas to which the target image will be printed) receive treatment. For either method, a single pass is often sufficient to apply the pretreatment solution to the printable surface. In this way, pretreatment can occur in the required process station time, thereby enabling higher speeds of the overall process. However, if more time is needed to apply the required amount of pretreatment, such as for thicker fabric garments, rather than increasing the dwell time at the station (which would necessarily increase the time in all stations), one or more additional pretreatment stations may be added, thereby having minimal impact on the overall process timing.

The pallet containing the resulting fabric substrate having the pretreated printable surface 122 (e.g., a pretreated fabric garment) then passes to one or more heating stations 130 (e.g., flash drying stations) at which heat is applied to dry and set the pretreatment. Any flash drier known in the art may be used, including those used to dry silk screened images. For example, in some embodiments, the flash drier includes an infrared heater. The number of flash drying stations depends, for example, on the type of fabric, the drying temperature, and the amount of time needed to thoroughly set and dry the pretreated fabric at that temperature. These may be determined experimentally or estimated empirically. The required drying time is then compared to the previously determined constant dwell time to be spent at each process station, and the number of needed flash driers can then be determined. For example, for drying a single-pass nozzle-pretreated cotton shirt at a preset temperature, four sequential flash drier stations may be used, as shown in FIGS. 1-6. Each heating station 130 may be programmable so that the temperature can be turned on prior to the pallet entering the station or may employ a temperature ramp to reach the desired drying temperature within the preset time. Also, each station may flash dry and set the pretreated fabric at the same average temperature, or each stage may use a different temperature, such as increasing or decreasing temperature steps, to achieve efficient heating without damage to the fabric.

As an illustrative example, assume that printing a target image on a t-shirt (at a later stage in the process, although a stage that another previously loaded t-shirt may currently be undergoing) takes 10 seconds. To ensure proper drying of the pre-treatment solution, it may be determined that, at a specified temperature X, it would take approximately 40 seconds to apply the desired amount of heat. As such, assuming the t-shirt dwells at each station for only 10 seconds (as dictated by the printing time), one solution would be to use four flash cure stations (10 seconds for 4 stations equals 40 seconds). Alternatively, heat may be increased and fewer flash cure stations may be used (e.g., 3 stations for a total of 30 seconds, at a higher drying temperature). Other combinations will be readily apparent to those skilled in the art, and those mentioned herein are merely for illustration of the adaptiveness of the system described herein.

After flash drying, the pallet containing the fabric substrate having the dried pretreated printable surface 132 (e.g., a dried pretreated fabric) may then pass to one or more optional heat press stations 140 at which, during the pre-established station dwell time, the fabric fibers are pressed in preparation for image printing. The number of heat press stations can be varied, depending, for example, on the temperature of the heat press and on the number of flash drying stations (e.g., the extent of drying of the pretreated fabric). It has been found that by using one or more heat press stations as an additional heating station for further heating and drying the pretreated fabric, overall drying time can be significantly reduced (e.g., one third the dry time required by only flash curing the garment), thereby improving efficiency and overall production speed, in addition to stretching and pressing the fibers of the fabric (which makes for better printing).

In this specific embodiment, the pallet containing the resulting fabric substrate having the pressed dried pretreated printable surface (e.g., a pressed dried pretreated fabric) then passes to one or more printer stations 150, such as a DTG printer, where ink is applied to produce the printed fabric product including the desired image. While many different types of printers may be used, in some embodiments the printer comprises an inkjet printer, which may be any inkjet printer known in the art. Inkjet ink compositions may be white or color inks (such as cyan, magenta, yellow, or black), including pigment based, resin based, or dye based colorants, and are formulated for the particular type of print head and nozzles in order to enable high speed printing of the chosen image onto the pressed dry pretreated fabric.

The number of print heads and nozzles may be chosen as needed in order to provide a final printed image in a time that is less than or equal to the preset station dwell time, as discussed in more detail herein. In particular, the number of print heads may be chosen to ensure that the entire image is capable of being printed in a single pass within the preset time. However, for some image designs, resolutions (e.g., higher dots per inch (DPI)), and fabric types, multiple passes of the print head may be needed. Multiple passes would either require increasing the station dwell time, which would reduce overall throughput (e.g., 50 garments per hour), especially for large batch operations, since all stations (e.g., pretreatment, flash drying, and heat pressing) would also include the increased time, or, alternatively, would produce a lower quality final printed image (durability, clarity, etc.) if a single pass is used (e.g., 300 or more garments per hour). Notably, as mentioned above, in some embodiments, the print station dictates the time spent at each station (the dwell time), and as such, also dictates the amount of heat that needs to be applied (temperature and/or number of heat/cure stations) in order to dry the pre-treatment solution sufficiently enough to be ready for printing.

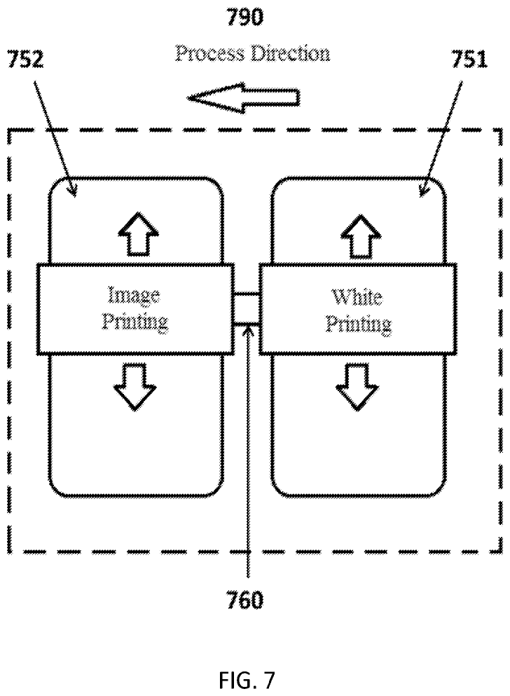

Therefore, in order to achieve high throughput in a single pass, based on the techniques described herein, it has been found that multiple consecutive printer stations can be used, with each station being configured to print a specific type of ink within the preset station dwell time. For example, as shown in FIG. 7, in some embodiments, the pallet containing the pressed dry pretreated fabric may pass in direction 790 through two consecutive and adjacent printer stations, 751 and 752. First printer station 751 may include an array of print heads configured for printing a first inkjet ink, and second printer station 752 may include an array of print heads configured for printing a second inkjet ink. In some embodiments, the array of print heads are linear (such as a linear array of eight print heads), and each array having a length that spans across the entire print area (e.g., across the width of print area of the fabric garment).

The print head of the first station may move independently of the print head of the second station, or, alternatively, the print heads of each station may be configured to move in tandem (e.g., on a single controlled arm 760). For example, the print heads of consecutive printer stations may be mechanically coupled so that a single pass may be made for all print heads while sequential pallets are positioned in adjacent printer stations. Note that, in this configuration, the print heads of each station need not apply ink on each “pass”. For example, if six passes at the first station are required, but only four passes at the second station are required, the ink jets of the second station may be configured to not apply ink for at least two of the passes. The same arrangement is possible in reverse as well: that is, fewer ink application passes on the first station than the second station. This would be expected to significantly simplify the mechanical design and operation of the printer, saving on space, efficiency, and cost.

As shown in FIG. 7, in a specific embodiment, the first printer station may be configured for printing a white inkjet ink, and the second printer station may be configured for printing colored inkjet inks. In this way, a white base may be printed onto the pressed dry pretreated fabric within the preset time of a single stage, which is then followed by printing of the color regions needed to complete the target image, also within the preset time and within a single stage. Accordingly, the white ink composition may be specifically formulated to dry (set up) quickly in order to allow proper application of the colored image at the next printing station. In some embodiments, a colored image may be applied over the white ink image without requiring additional steps in between the two stages. Alternatively, additional steps and/or stations, such as flash and/or heat press processes may be provided between printing the white image and the colored image.

Illustratively, as shown in FIG. 7, in order to achieve the desired result in a single “back and forth” motion, the print heads for both the white and color stages may be arranged width-wise to cover the entire desired print area (e.g., a 16″ inch array width), such that one or more back and forth passes (e.g., 20″ up and back) will complete the desired printing process of the entire image without any “side to side” motion required to reposition the print heads. Note that although conventional DTG printers today typically perform around 32 “passes” (printer head passes over the garment) with white ink and 16 passes with color ink, due to the number of print head repositions, the techniques herein and the specifically configured print heads may create the same or better quality images with only 4-10 total passes (depending upon desired level of resolution).

Notably, when the first printer station (e.g., white ink) immediately follows a heating station, such as a heat pressing station, advantages may be gained by the garment still being warmed. That is, the pressed dry pretreated fabric may still be warmed due to time since the last heating of the garment, in addition to the general warming of the pallet (e.g., a metal pallet) holding the fabric over continued processing time. The white ink, printed on the heated surface, would therefore set faster (compared to being printed on a cool pre-dried surface), providing a cured surface for the color printing and increasing the speed of the overall printing process.

As mentioned above, if additional ink is needed in order to achieve the desired print quality, adjacent parallel print heads may be included in a printer station, such as an array of sixteen print heads, formed by adjacent and parallel linear arrays of eight print heads. Each linear array can be configured to print the desired color and/or combinations of colors needed to achieve the desired print quality. By using parallel arrays of print heads, additional ink can be applied without adding additional printer stations or increasing the printing time that would thereby increase the preset dwell time in each station. Illustratively, for example, if more white ink is needed for the base coat prior to printing the color image, sixteen print nozzles (e.g., two rows of eight) may be used on the white print head, and eight nozzles (e.g., a single row) may be used on the color/image print head, thus providing for twice as much ink application of white versus color within the same number of (illustratively tandem) passes of the print heads.

After the image print is complete, the pallet containing the printed fabric garment may, if needed, further pass to one or more optional heating stations to cure and set the printed image. Any of the heating stations, including the flash dry stations described above, can be used.

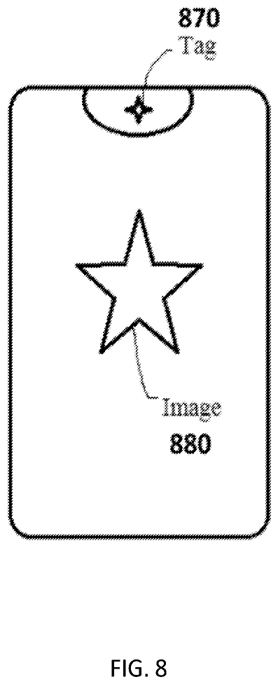

For example, as shown in FIG. 8, in certain embodiments, the pallets may be configured to allow simultaneous print access to both the garment image-printable area and the “tag” located inside of the garment at the neck (as will be understood by those skilled in the art). For instance, many garments now replace the conventional “sewn-in” tag (manufacturer information, wash instructions, etc.) with a printing of the information. With an advanced pallet design that exposes this tag area in addition to the primary image area, the printers may be further configured to print tag 870 at the same time as image 880. In such, configurations, it may be beneficial (or required) to add one or more drying stations (e.g., one or more flash cure stations) in order to ensure that the printed neck tag has dried sufficiently enough to allow the opposing portion of the garment (e.g., the top of the shirt) to touch the neck tag without smearing it. This may simplify the neck tag printing systems and methods. In some instances, this may be more efficient and cost effective than traditional methods of printing neck tabs, which may include pad print, or heat transfer foil or film, which may be multi-step processes. For instance, traditional neck tag printing methods may include printing a main print area on a garment, and then decorating the neck tag by the previously mentioned methods. The systems and methods provided herein may allow the main area and the neck tag area to be printed in the same printing process.

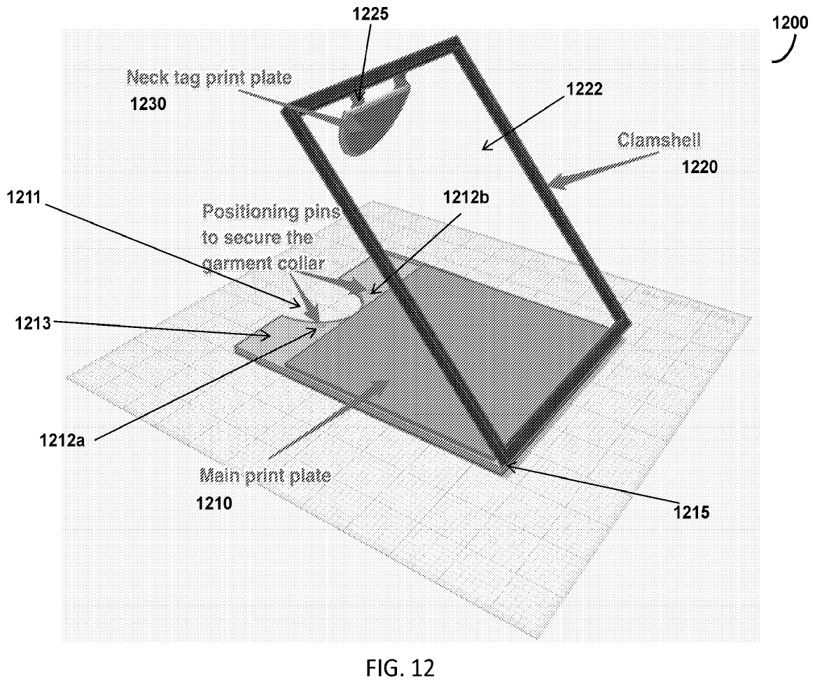

FIG. 12 shows an example of a neck tag pallet 1200 to allow direct to garment printing for the neck tag, in accordance with embodiments of the invention. A neck tag pallet may also be referred to as a pallet assembly. Any description elsewhere herein of a pallet may also apply to a neck tag pallet and vice versa. For instance, the neck tag pallets may traverse the closed-loop, direct to garment printing apparatus as described elsewhere herein.

The neck tag pallet 1200 may include a main print plate 1210, a clamshell 1220, and a neck tag print plate 1230.

The main print plate 1210 may comprise a substantially flat and planar area. The main print plate may have a square or rectangular shape. At least a portion of the main print plate may be configured to be inserted within a garment when the garment is loaded onto the pallet assembly. A bottom opening of the garment may be opened, to accept the main print plate. The main print plate may have a width that is close to a width of a body of the garment. The garment may be stretched to be fitted over the main print plate. In some instances, the garment may not need to stretch to be fitted over the main print plate. An operator may load the garment onto the main print plate and flatten the garment so that the garment forms a flat, unwrinkled surface over the main print plate. A front part of the garment may be on top of the main print plate.

Any material with desirable properties may be used to form the main print plate. The main print plate may be formed from a rigid or semi-rigid material. The main print plate may or may not be formed from an elastic or depressible material. The main print plate may be formed from a metal, plastic, wood, foam, rubber, or other material. The main print plate may be cushioned. The main print plate may be formed from a high-friction material that may prevent the garment from unnecessarily sliding around.

The main print plate 1210 may optionally include, or be supported by, a substrate 1213. The substrate may be formed from a rigid or semi-rigid material. The substrate may be inserted into the garment when the garment is loaded on the main print plate. The substrate may be formed from the same material as the main print plate or a different material. The substrate may form a single integral piece with the portion of the main print plate that comes into the contact with the front of the garment, or may be formed from a separate piece. Optionally, the main print plate may rest on top of the surface of the substrate. The main print plate may optionally be raised from the surface of the substrate.

The main print plate and/or substrate may include a neck cut-out 1211. The neck cut-out may allow a neck tag region of the garment to be exposed when the garment is loaded on the main print plate. The neck cut-out prevents the main print plate or substrate from covering the neck tag region. The neck tag region may be on an inner, top surface of the garment.

The neck cut-out may have a curved shape. The neck cut-out may be contoured to mirror or follow a collar of a garment. The neck-cut-out may have a semi-circular or semi-elliptical shape. In other instances, the neck cut-out may have a rectangular shape, or any other shape that may sufficiently expose the neck tag area. The neck cut-out may be open at the top. The neck cut-out need not to be completely be surrounded or enclosed by the substrate or main print plate. In other embodiments, the neck cut-out may be provided as a hole and/or may be enclosed by the substrate or main print plate.

The main print plate and/or substrate may include one or more positioning pins 1212a, 1212b. In some embodiments, two or more, three or more, four or more, or additional positioning pins may be provided. The positioning pins may extend up out of the main print plate and/or substrate supporting the main print plate. The positioning pins may have a substantially cylindrical shape and/or prismatic shape. In some embodiments, the positioning pins may comprise a flange, lip, hook, or overhang. The positioning pins may be used to secure a collar of the garment. A flange, lip, hook or overhang may be useful in preventing the collar of the garment from slipping off the positioning pins.

The positioning pins may be positioned at or near a border of a neck cut-out. The positioning pins may be positioned within 0.1 cm, 0.3 cm, 0.5 cm, 0.7 cm, 1 cm, 1.5 cm, 2 cm, or 3 cm or a neck cut-out. The positioning pins may be positioned in a manner that prevents the front portion of the garment from covering the neck cut-out or a neck tag region when the garment is loaded on the pallet. The positioning pins may or may not cause the collar of the garment to be stretched to expose the neck tag region.

A clamshell 1220 may be coupled to a main print plate 1210. For instance, the clamshell may be directly coupled to the main print plate, or may be coupled to a substrate that may support the main print plate. The clamshell may rotate relative to the main print plate. The clamshell may rotate about a hinge or other connector that may couple the clamshell to the main print plate. A rotational axis of the clamshell relative to the main print plate may pass through the hinge 1215 or another connector. The clamshell may rotate freely about the rotational axis. Alternatively, the rotational range of the clamshell may be limited. For instance, the clamshell may rotate up to about 45 degrees, 60 degrees, 75 degrees, 90 degrees, 120 degrees, or 180 degrees. A hinge or connector may or may not be spring loaded. A hinge or connector may or may not bias the position of the clamshell into a resting position.

A clamshell may rotate between an open position and a closed position relative to the main print plate. An open position may be provided while a garment may be loaded onto the main print plate or unloaded from the main print plate. The clamshell may be sufficiently open to allow the garment to be slipped on over the main print plate, so that a front of the garment comes between an upper surface of the main print plate and the clamshell. A closed position may be provided to secure the garment to the main print plate. In the closed position, the clamshell may be substantially parallel to the main print plate. In the closed position, the clamshell may press down on portions of the garment. The clamshell may be configured to be press-fit over the main print plate. A frictional fit may be provided that may prevent the clamshell from slipping open, and allow the pallet to traverse a direct to garment printing apparatus without coming open. Optionally, a weight of the clamshell may be sufficient to hold it down and prevent the garment from slipping, or the clamshell from coming open. A locking mechanism may or may not be provided that may prevent the clamshell from coming open when locked.

An opening 1222 may be provided for the clamshell. The clamshell may optionally comprise a frame, having an opening therein. In some embodiments, the opening may form at least 80%, 85%, 90%, 95%, 97%, or 99% of an area of the clamshell. The opening may allow the front side of the garment to be exposed. This may allow the direct to garment printing apparatus to print on a main print area and/or neck tag area of the garment. In some instances, a single opening may be provided, which may expose both the main print area and the neck tag area. Alternatively, multiple openings may be provided. For instance, a separate opening may be provided for the main print area and the neck tag area. Any description herein of an opening may also apply to multiple openings. The frame may be formed from a substantially rigid or semi-rigid material. The frame may or may not be formed from a stretchable material. The frame may have a top surface that may cover a front surface of the garment and/or print plate. The frame may optionally have one or more side surfaces that may overlap with and/or cover a side of the metal print plat and/or substrate. In some instances, the frame may have four side surfaces that may circumscribe the metal print plate and/or substrate.

The clamshell may secure the edges of the garment and provide a flat surface of the garment to be exposed to the various stations. When the garment is loaded, the front surface of the garment may be flattened to prevent wrinkling or unwanted distortion of the surface.

A neck tag print plate 1230 may be supported by the clamshell 1220. The clamshell may bear the weight of the neck tag print plate. The neck tag print plate may be coupled to the clamshell with aid of a hinge 1225 or other connector. The neck tag print plate may rotate relative to the clamshell. The neck tag print plate may rotate about a hinge or other connector that may couple the neck tag print plate to the clamshell. Optionally, a pair of hinges or any number of hinges may be provided to support the neck tag print plate. A rotational axis of the neck tag print plate relative to the clamshell may pass through the hinge 1215 or other connector. The neck tag print plate may rotate freely about the rotational axis. Alternatively, the rotational range of the neck tag print plate may be limited. For instance, the neck tag print plate may rotate up to about 45 degrees, 60 degrees, 75 degrees, 90 degrees, 120 degrees, or 180 degrees. A hinge or connector may or may not be spring loaded. A hinge or connector may or may not bias the position of the neck tag print plate into a resting position. In some embodiments, a spring or other mechanism may bias the neck tag print plate in an upward position. The neck tag print plate may be substantially parallel and/or coplanar with the clamshell when in the upward position. The neck tag print plate may be manually turned to a downward position, but may return to the upward position when released. In some embodiments, a neck tag print plate may be coupled at a hinge 1225 on a side of the clamshell that is opposite/opposing a side through the hinge 1215. The neck tag print plate may be supported on a portion of the clamshell that extends furthest from the hinge 1215.

A neck tag print plate may rotate between an upward position and a downward position relative to the clamshell. A downward position may be provided while the clamshell is being moved downward to be closed on the garment and/or metal print plate. The neck tag print plate may be substantially perpendicular to the clamshell when in the full downward position. The neck tag print plate may be greater than or to 90 degrees relative to the clamshell when in the downwards position. The neck tag print plate may be sufficiently pulled away from the clamshell to prevent the neck tag print plate from getting stuck on the garment, and the allow the neck tag print plate to move downwards beneath the back surface of the neck region of the garment when the clamshell is being closed. An upward position may be provided to secure the back surface of a neck region of the garment to the main print plate. After the clamshell is closed, the neck tag print plate may be released and allowed to swing upwards. The neck tag print plate may come up behind the back of the neck tag region of the garment, and push it upwards. In the upward position, the neck tag print plate may be substantially parallel to the clamshell. In the upward position, the neck tag print plate may push up the neck tag portion of the garment to be substantially in line with the main print plate. The neck tag print plate may be substantially coplanar with the metal print plate when in the upward position. This may allow the neck tag area and the main print area to be at the same level. The neck tag area and the main print area may be substantially coplanar when the neck tag print plate is in an upward position. Optionally, the neck tag area and the main print area may be at the same level as an upper surface of a clamshell when the clamshell is closed. In some instances, the neck tag area and the main print area may be at a slightly higher level than the upper surface of the clamshell when the clamshell is closed. The neck tag area and the main print area may protrude out through one or more openings (i.e., open area), of the clamshell when the clamshell is closed.

The neck tag print plate may have any shape. The neck tag print plate may have a substantially curved shape. The neck tag print plate may be contoured to mirror or follow a shape of a neck cut-out on a main print plate or substrate. The neck tag print plate may have a semi-circular or semi-elliptical shape. In another example, the neck tag print plate may have a substantially rectangular shape, circular shape, elliptical shape, or any other shape. The neck tag print plate need not match or follow the neck cut-out shape. The area of the neck tag print plate may be less than or equal to the area of the neck cut-out. The neck print plate may align with a top of the metal print plate or substrate supporting the metal print plate. The neck cut-out may optionally need to be completely be surrounded or enclosed by the substrate or main print plate. The neck tag print plate may be slightly smaller than the neck cut-out to allow the garment to pass between the neck tag print plate and the neck cut-out. The neck tag print plate may push up the back neck portion of the garment through the neck cut-out when in an upward position.

Any material may be used to make the neck tag print plate. The material of the neck tag print plate may match a material of the main print plate. The material of the neck tag print plate may share one or more characteristics of the main print plate, such as hardness, flexibility, elasticity, and so forth. In some instances, the neck tag print plate may be formed from a rigid or semi-rigid material. The neck tag print plate may or may not be formed from an elastic or depressible material. The neck tag print plate may be formed from a metal, plastic, wood, foam, rubber, or other material. The neck tag print plate may be cushioned. The neck tag print plate may be formed from a high-friction material.

The neck tag print plate may elevate the neck tag region of the garment and provide a flat surface of the garment to be exposed to the various stations. When the garment is loaded, and the neck tag pallet secured, the main print area and the neck tag area may be at the same height, which may allow the stations to function with little or no modification. For instance, the same printer heads may be used to pretreat, print, and/or apply a top coat on the neck tag and main print area. Similarly, the same heating and/or drying mechanisms may be used to dry and/or cure the neck tag area and the main print area.

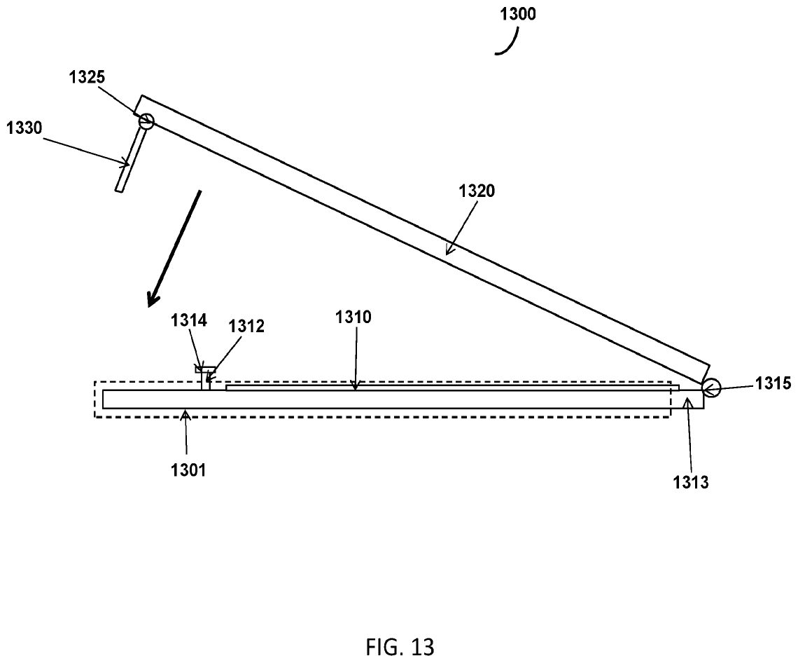

FIG. 13 shows an example of a clamshell of a pallet assembly 1300 in an open position. The pallet assembly may comprise a main print plate 1310, clamshell 1320, and neck tag print plate 1330. The main print plate may optionally comprise or be supported by a substrate 1313. The clamshell may be rotatable between an open position and a closed position. The clamshell may be coupled to the main print plate and/or substrate via a hinge 1315 or other type of connector that may allow rotation. The neck tag print plate may be supported by the clamshell and rotatable between an upward and down position via a hinge 1325 or other type of connector.

The pallet assembly may be configured to accept a garment 1301. The garment may be any type of article of clothing, or any other type of textile product. The garment may be wearable over a torso of an individual. The garment may be a shirt, such as a T-shirt, dress shirt, tunic, bodysuit, or any other type of shirt. The garment may have no sleeves, straps, short sleeves, three-quarter sleeves, or long sleeves. The garment may have a neck tag area. The garment may have a collar.

The garment may be loaded onto the pallet assembly by inserting a metal print plate and/or substrate into the garment. A printable area of the garment may be on a top surface, facing the clamshell. The bottom of the garment may be closer to the hinge 1315 connecting the clamshell to the main print plate and/or substrate, while the top of the garment (e.g., neck tag area) may be away from the hinge. The garment may be pulled sufficiently down and flattened to prevent wrinkling or distortion of the front surface. The garment may be pulled sufficiently down so that the neck tag region of the garment is exposed via a neck cut-out. The garment may be pulled down so that the shoulder regions of the garment contact the portion of the metal print plate and/or substrate. A collar of the garment may be secured with aid of one or more positioning pins 1312. The positioning pins may include one or more flange 1314, lip, hook, or overhang. This may prevent the collar of the garment from slipping off the positioning pin. Positioning the collar with the positioning pins may ensure that the neck tag region of the garment is exposed.

The garment may be loaded manually with aid of an operator. For instance, an individual may be located at an operator station and may load and/or unload the garment. In alternative embodiments, the garment may be loaded automatically with aid of one or more unmanned devices. The pallet assembly may optionally be used in a closed-loop, direct to garment printing apparatus, as described elsewhere herein. In some embodiments, an operator may stand outside the loop, at an operator station. Alternatively, the operator may stand within the loop. The pallet assembly may be configured so that the clamshell opens in a manner so that the opening faces the operator. For instance, if an operator is outside the loop, the pallet assembly may be configured so that the clamshell opens up toward the outside of the loop (e.g., the neck tag area is closer to an outer part of the loop). If an operator within the loop, the pallet assembly may be configured so that the clamshell opens up toward the inside of the loop (e.g., the neck tag area is closer to an inner part of the loop). In alternative embodiments, the reverse may occur.

After the garment has been loaded onto the pallet assembly, the clamshell may be brought down to a closed position. The neck tag print plate 1330 may be in a down position while the clamshell is being brought down. The neck tag print plate may be close to a perpendicular position relative to the clamshell while the clamshell is being brought down. The neck tag print plate may be in a position to not interfere with the garment while the clamshell is being brought down.

The clamshell may be brought down manually with aid of an operator. In alternative embodiments, the clamshell may be brought down automatically with aid of an actuator (e.g., motor) or one or more unmanned devices.

In some alternative embodiments, a pallet may not have a clamshell. In some instances, alternative means may be used to fasten a garment or keep the garment at a desired position on the pallet. For instance, a sticky pallet, adhesives, or pallet with high frictional values may be used to keep a garment from slipping. In some instances, hook and loop fasteners or other fasteners may be used to secure a garment. In some instances, a static charge may be built or utilized to hold a garment stay in place on a pallet. In some instances, this may be advantageous for items that may not fit well with a clamshell (e.g., backpacks, bags, or thick items). In such situations, a clamshell may not be attached to the pallet or may be removed from the pallet. In some situations, clamshell may be folded in a manner so that it does not interfere with the process.

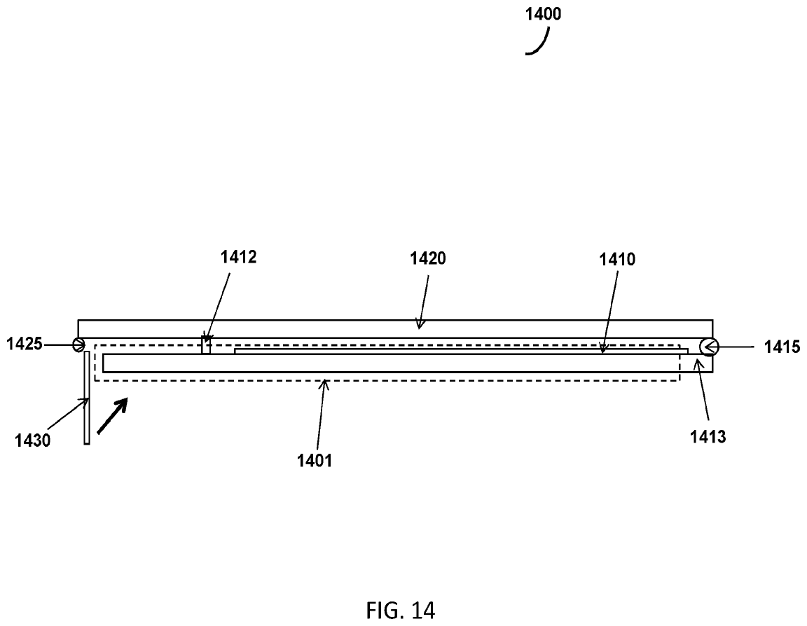

FIG. 14 shows an example of a clamshell of a pallet assembly 1400 in a closed position with a neck print plate in a down position, in accordance with embodiments of the invention. A garment 1401 may be loaded within the pallet assembly, such that a main print plate 1410 and/or substrate 1413 are within the garment. The garment may be positioned so that a main print area is facing the clamshell 1420. One or more positioning pins 1412 may hold a collar of the garment to ensure that a neck tag area of the garment is exposed and facing the clamshell. The clamshell may include an open area that allows a main print area and the neck tag area to be exposed. This may allow for printing on the main print area and the neck tag area. The clamshell may be connected to the main print plate and/or substrate via a hinge 1415 or any other type of connector.

A neck tag print plate 1430 may be supported by the clamshell 1420. The neck tag print plate may be rotatable around a hinge 1425 or any other type of connector. The connector may include a spring or other type of biasing mechanism that may cause the neck tag print plate to be in an upward position (e.g., in-line or parallel with the clamshell) in a relaxed state. A neck tag print plate may be pulled into a down position, but may require force to keep the neck tag print plate in the down position. The neck tag print plate may be in the down position while the clamshell is being closed. This may be to prevent the neck tag from getting caught on the garment while the clamshell is being closed. The neck tag may remain in the down position until the clamshell is completely closed.

When the clamshell is completely closed, the garment may be secured to the pallet assembly. The garment may be prevented from slipping with respect to the pallet assembly. This may ensure that the garment is securely positioned, which will improve the quality of the images provided on the garment.

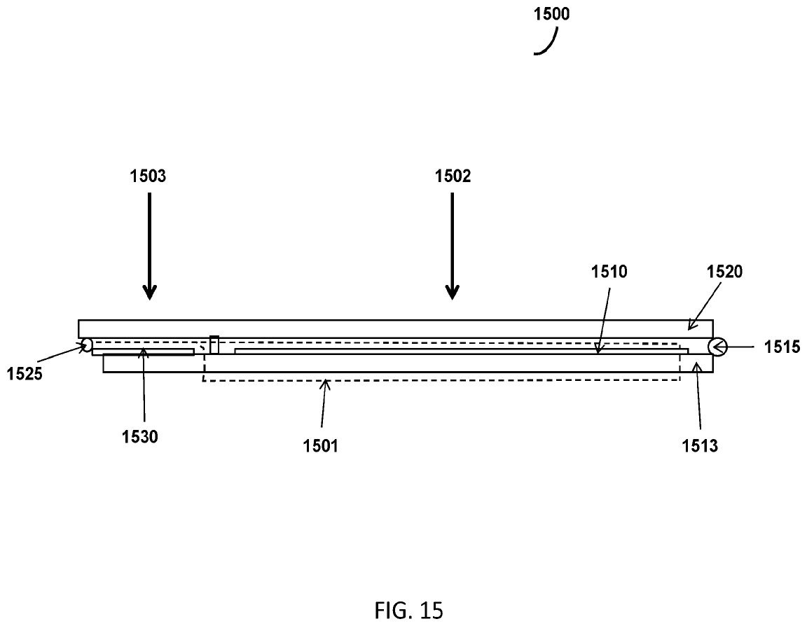

FIG. 15 shows an example of a clamshell 1520 of a pallet assembly 1500 in a closed position with a neck print plate 1530 in an upward position. After a garment 1501 has been loaded on the pallet assembly, and the clamshell has been closed, the neck tag print plate may be brought into an upward position. In some instances, the neck tag print plate may be released, which may automatically allow the neck tag print plate to return to an upward position. For instance, a hinge 1525 with a spring or other type of biasing mechanism may cause the neck tag to return to an upward position, relative to the clamshell.

The neck tag print plate may lift a back portion of the garment including the neck tag area by a sufficient amount to be in-line with the main print area. This may be by at least 0.1 cm, 0.3 cm, 0.5 cm, 0.7 cm, 1 cm, 1.2 cm, 1.5 cm, 2 cm, 2.5 cm, 3 cm or more.

For instance, an operator may be holding a neck tag print plate in a downward position while the clamshell is closed. When the clamshell has been completely closed, the operator may let go of the neck tag print plate, which may return to an upward position without requiring any further manual manipulation. For instance, tension from a spring-loaded hinge or other connector may cause the neck tag print plate to go to an upward position. In other embodiments, an operator may push the neck tag print plate to an upward position, or the neck tag print plate may return to an upward position with aid of one or more actuators or one or more unmanned devices. Optionally magnets or other mechanisms may be used to cause the neck tag print plate to return to an upward position.

When the neck tag print plate is in an upward position, it may bring the neck tag area of the garment upwards, and support the neck tag area. This may include bringing up a back portion of the garment around the neck tag area. The neck tag print plate may be substantially co-planar with a main print plate when in an upward position. The neck tag area may be substantially coplanar with the main print area when the neck tag print plate is in an upward position.

Having an exposed neck tag area 1503 and main print area 1502 may be advantageous when adding digital images to both areas. This may allow interaction with various stations without having to significantly modify the stations. For instance, both the main print area and the neck tag area may be pretreated using the same set of nozzles. Similarly, the same heating, drying and/or curing processes may be used for both the main print area and the neck tag area, since they are at the same level. Similarly, printing may occur to both the main print area and the neck tag area using the same set of nozzles. This may be true for printing both white and color layers. A head carriage may move relative to an entire length of the garment, including a neck tag printing area and main print area, to pretreat and/or print both the main print area and the neck tag area. For instance, both the neck tag area and the main print area may be pretreated and/or printed on one or more (or each) pass of a print head carriage. For drying a neck tag print, when the pallet assembly indexes to a drying station, the neck tag flash may turn on and cure the printed image on a neck tag area. The printed image on the neck tag may be partially cured (e.g., dry to touch) which may allow the operator to unload the garment without having the ink smearing. Any of the steps for the main print area and the neck tag printing area may occur together or separately. For example, the same dryer/heaters and/or curing stations or apparatus may be used for both areas. Alternatively, one or more of the areas may have a dedicated area, such as a main print area flash and/or a neck tag area flash.

The pallet assembly may circulate through a closed-loop system as described elsewhere herein. Any number of pallet assemblies may simultaneously traverse the closed-loop system. For instance, at least two or more, three or more, four or more, five or more, six or more, eight or more, ten or more, twelve or more, fifteen or more, twenty or more, twenty-five or more, or thirty or more pallet assemblies may be simultaneously processed within the closed-loop system. The pallet assemblies may be secured at the same elevation or level while traversing the closed-loop system. Alternatively, the pallet assemblies may travel up or down as needed within the system (e.g., at one or more stations). The garment may be secured to the pallet assembly, and the neck tag print plate may allow the neck tag area and the main print area to be treated in the same manner as the garment traverses the various stations. Alternatively, additional processes may be provided for the neck tag area.

After a printing and/or drying process is finished, the garment may be unloaded from the pallet assembly. The neck tag print plate may be pulled to a downward position while the clamshell is being opened. Then the garment may be removed from the main print plate and/or substrate. The unloading may occur with aid of an operator. Alternatively, one or more automated processes may be used to unload the garment. The unloading may occur at an operator station where the garment was originally loaded.

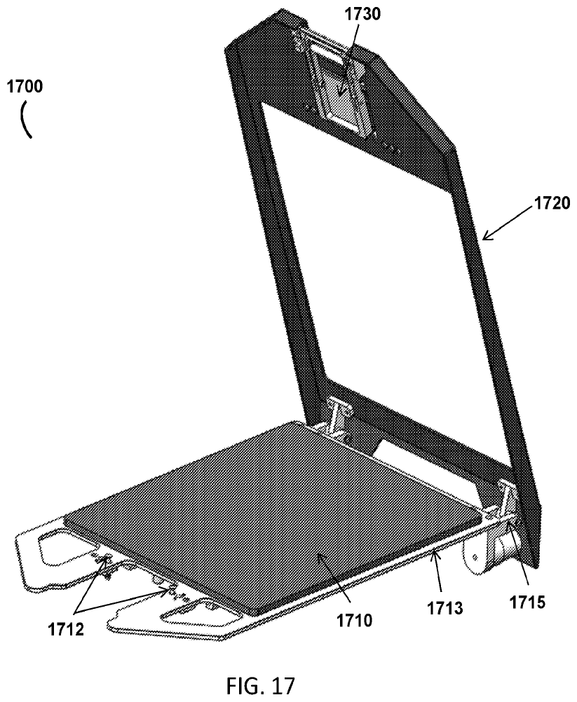

The pallet assembly may have any configuration that may facilitate printing in the neck tag area as described. FIG. 17 shows an exemplary pallet assembly 1700 with an open clamshell 1720. As described elsewhere herein, a clamshell may be optional or removable. A main print plate 1713 may include or be supported by a substrate 1713. The main print plate may fit within an opening in the clamshell. The main print plate may optionally extend at least partway through the opening. The clamshell may rotate about a hinge 1715. One or more positioning pins 1712 may extend up from the substrate and/or main print plate. A neck tag print plate 1730 may optionally be biased toward an upward position.

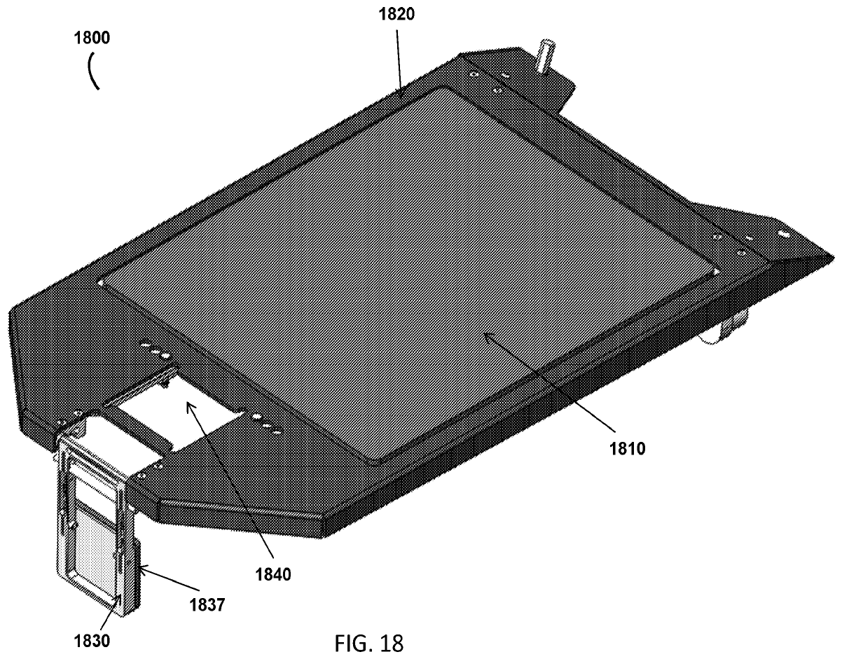

FIG. 18 shows an exemplary pallet assembly 1800 with a closed clamshell 1820 and a neck print plate 1830 in a down position. The neck print plate may optionally be pulled to a down position while the clamshell is being closed. This may prevent interference of the neck print plate with a garment on the pallet assembly. A portion or an entire area of a main print plate 1810 may be exposed by an opening in the clamshell. The main print plate may extend partially through an opening in the clamshell. An upper surface of the main print plate may be higher than an upper surface of the closed clamshell. The clamshell may optionally include one or more neck tag area openings 1840. A neck tag print plate may include a neck tag print pad 1837.

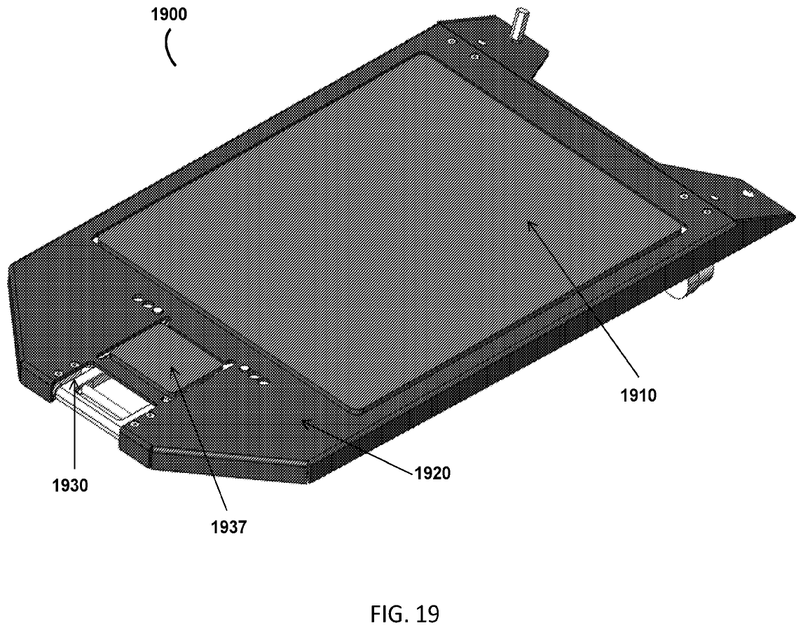

FIG. 19 shows an exemplary pallet assembly 1900 with a closed clamshell 1920 and a neck print plate 1930 in an upward position. As described, a main print plate 1910 may be provided at an opening of the clamshell. This may allow a main print area of a loaded garment to be exposed for printing. A neck tag print pad 1937 may be provided in a neck tag opening of the clamshell. This may allow for the neck tag area of a loaded garment to be exposed for printing. The main opening and the neck tag opening of the clamshell may serve as windows that may provide access to the various print areas of the garment. The neck tag print pad and the main print plate may be co-planar. An upper surface of the neck tag print pad and upper surface of the main print plate may be at the same level (e.g., co-planar). This may simplify the printing process for these areas.

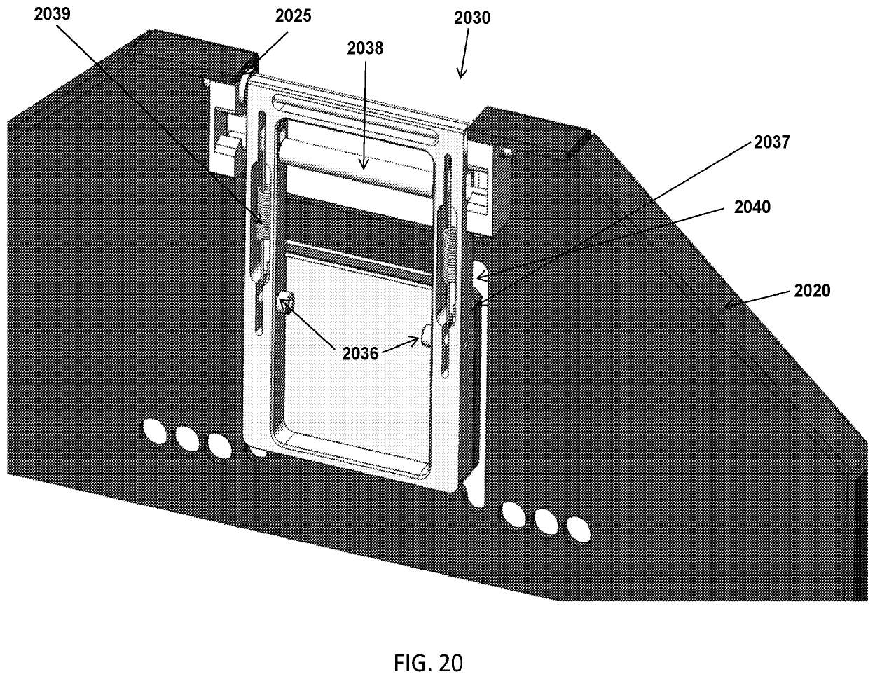

FIG. 20 shows a close-up view of an exemplary neck print plate 2030 in accordance with an embodiment of the invention. The neck print plate may be supported by a clamshell 2020. The neck print plate may pivot about a rotational axis, such as hinge 2025. The neck print plate may support a neck print pad 2037. The neck print pad may push up a neck tag area of a garment when the garment is loaded on the pallet assembly.

The neck print plate may include a biasing mechanism that may cause the neck print plate to be biased to an upward position. The neck print plate may be pulled or manipulated to a down position. The neck print plate may at a down position when a force is applied. In the absence of the force, the neck print plate may automatically revert to an upward position. In some instances, a biasing mechanism may include one or more springs 2039. A pair of springs may optionally be provided. A spring may be a coil spring, cantilever spring, flat spring, torsional spring, tension/extension spring, compression spring, a constant force spring, or any other type of spring. In some instances, springs may be attached at two or more anchor points, such as a distal anchor point 2036 and a proximal anchor point 2038. In some instances, one or more anchor points, such as a proximal anchor point 2038 may be attached to a bar or other mechanism that may slide with respect to the neck tag print plate. In some instances, the proximal anchor point or bar may be at a different location from the rotational axis, which may bias the neck tag print plate to the upward direction.

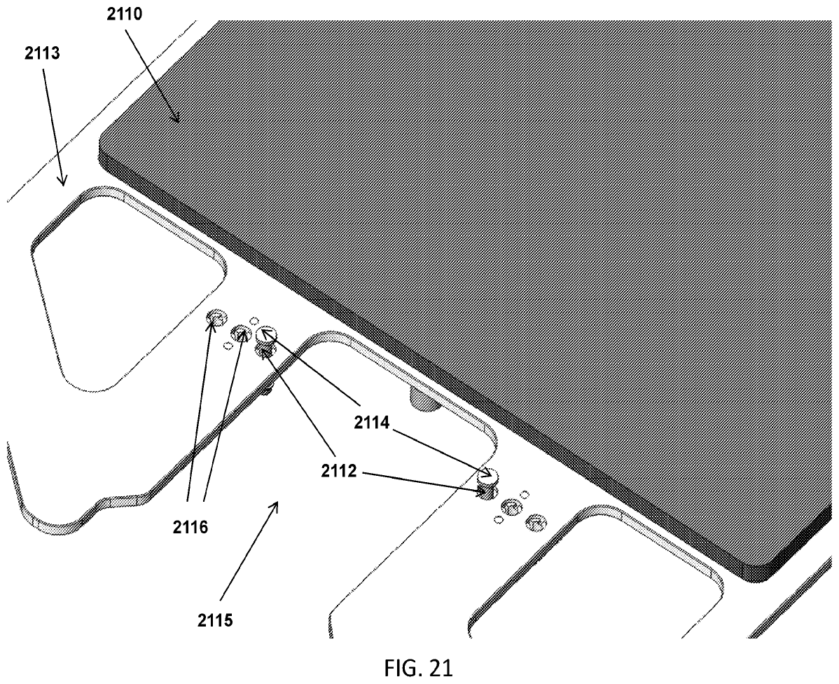

FIG. 21 shows a close-up view of an opening in the pallet assembly configured to expose a neck tag region, in accordance with embodiments of the invention. As described, a metal print plate 2110 may include or be supported by a substrate 2113. The substrate may include an opening or open region 2115 that may allow a neck tag region of a garment to be exposed when the garment is loaded on the pallet assembly.

One, two, or more positioning pins 2112 may be provided. The positioning pints may include a flange 2114 or other mechanism that may aid in securing portions of the garment. The positioning pins may be positioned to allow a front surface of the garment to be pulled down, exposing the neck tag region of the garment. The positioning pins may have a variable height or a fixed height. In some instances, the positioning pin position may be varied by sliding the positioning pins along a bar, or inserting the positioning pins into different openings 2116. This may allow different types, sizes, or shapes of garments to be accommodated. Optionally, a clamshell may have one or more holes/openings through which the positioning pins may extend. This may allow the clamshell to close tightly, even when the positioning pins are protruding upwards. The clamshell may have multiple holes/openings, to accommodate the positioning pins be placed at different locations.

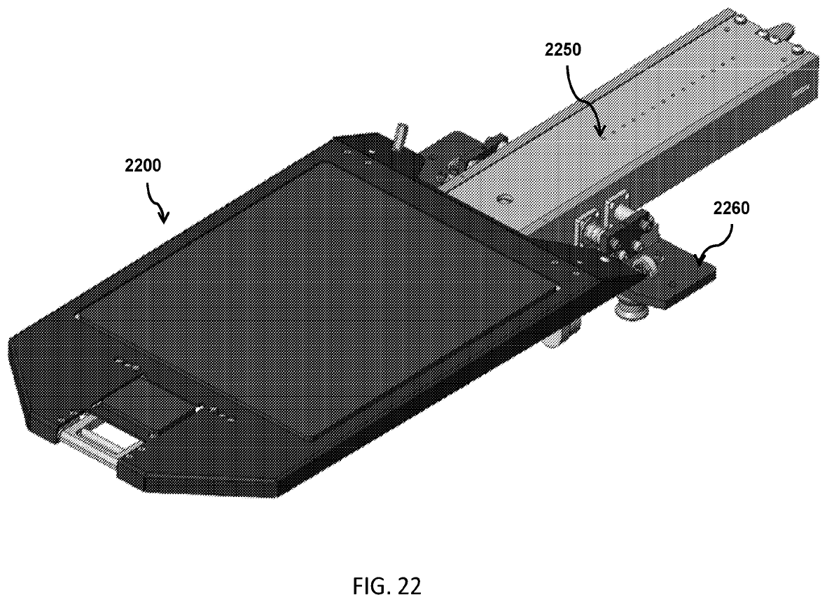

FIG. 22 shows an upper view exemplary pallet assembly 2200 supported by an arm 2250. The pallet assembly may have any of the features and characteristics as described elsewhere herein. The pallet assembly may be configured to support a garment while the garment traverses a printing apparatus. The pallet assembly may allow for printing of a main print area and a neck tag region, as described elsewhere herein.

An arm 2250 may be coupled to the pallet assembly. The arm may be an elongated structure. The arm may have an axis extending along the length of the arm that may coincide with or be parallel to an axis extending along a length of the pallet assembly. The arm may support the pallet assembly. The arm may be configured to bear the entire weight of the pallet assembly, or a portion of the weight of the pallet assembly. The arm may aid in keeping the pallet assembly aligned in a desirable manner as the pallet assembly may traverse the printing apparatus. One or more additional supporting features 2260 may be provided. Additional supporting features may aid in bearing weight of the pallet assembly, providing alignment for the pallet assembly, and/or aid in causing the pallet assembly to traverse the printing apparatus.

The arm and/or supporting features may be part of the printing apparatus. The arm and/or supporting feature may be coupled to an actuator, or may be coupled to a movable portion of the printing apparatus, that may allow the pallet assembly to traverse the printing apparatus.

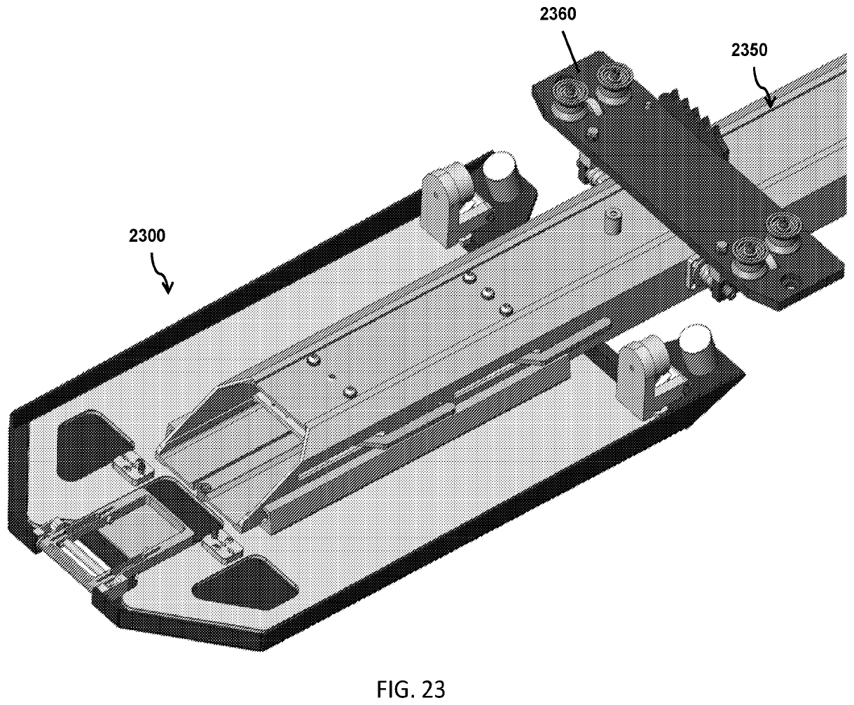

FIG. 23 shows a lower view of an exemplary pallet assembly 2300 supported by an arm 2350. One or more supporting features 2360 may be provided. The supporting feature may include a plate that may extend substantially perpendicularly or transversely with respect to the arm. The supporting feature may be coupled to the arm and/or configured to interface with the rest of the printing apparatus. The supporting feature may bear the weight of the entire arm or a portion of the weight of the arm.

One or more vibration dampeners may be provided on the support feature. This may allow the arm and/or pallet assembly to remain relatively steady as they traverse the printing apparatus. This may reduce the vibrations experienced by the pallet assembly which may reduce inaccuracies while printing an image on a garment supported by the pallet assembly. The vibration dampeners may reduce vibrations experienced in a vertical direction. Similarly, vibration dampeners may be provided that may reduce vibrations experienced in a lateral direction. The vibration dampeners may include one or more sets of springs, pneumatic or hydraulic pistons, or any other structure.

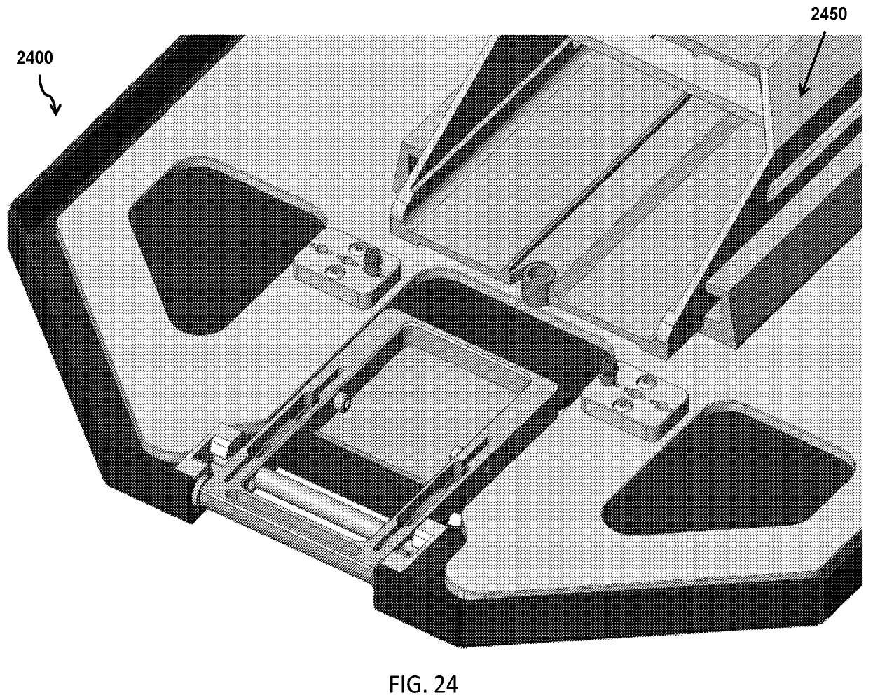

FIG. 24 shows a close-up of a lower view of an exemplary pallet assembly 2400. An arm 2450 may be coupled to the pallet assembly. The arm may or may not be configured to allow the pallet assembly to move relative to a longitudinal axis of the arm. For instance, one or more sliding or telescoping mechanism may be provided that may allow a pallet assembly to move longitudinally. Alternatively, the arm may have a fixed length and/or the pallet assembly may have a fixed position relative to the arm. The pallet assembly may be permanently affixed to the arm, or may be repeatedly removable relative to the arm. This may be useful when it is desirable to switch in different types of pallet assemblies that may have different features. This may provide additional flexibility to the printing apparatus. For instance, different pallet assemblies having different dimensions, materials, shapes, locations of printing regions, accommodating for different types of garments, or other features may be provided. A removable pallet assembly may be affixed to an arm or other support with aid of one or more fasteners. In some instances, a quick release assembly may be utilized. A quick release mechanism may allow the pallet assembly to be removed or added without requiring additional tools. A user may manually add or remove the pallet assembly manually by hand (e.g., with less than or equal to one motion, two motions, three motions, or four motions).

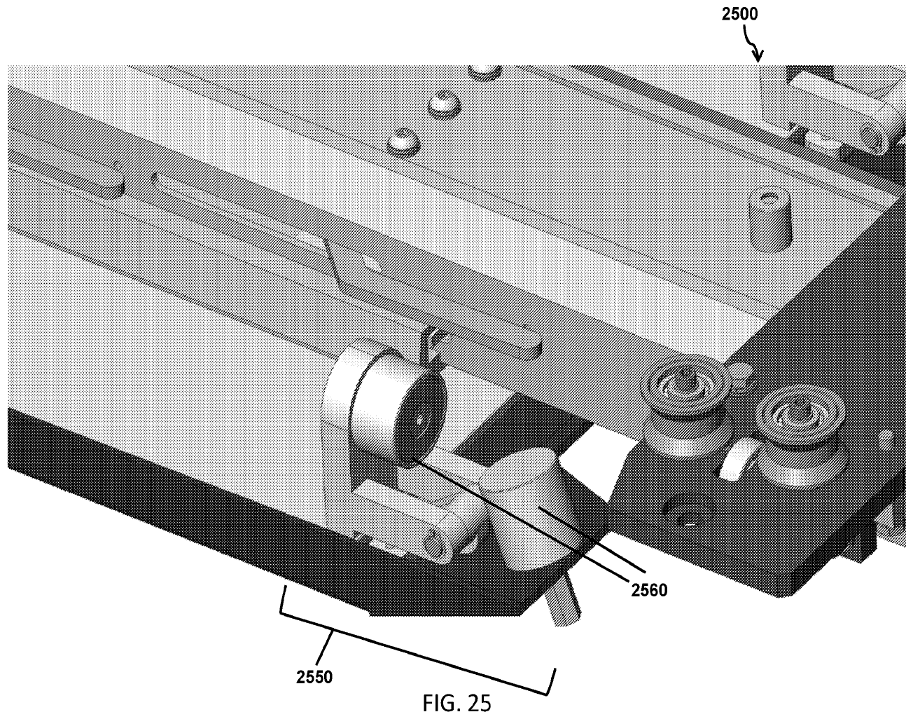

FIG. 25 shows a close-up of a side feature 2550 of an exemplary pallet assembly 2500. The side feature may include a hinge that may allow a clamshell of a pallet assembly to open and close. In some instances, one or more stoppers 2560 may be provided that may limit the degree to which the clamshell may be opened.

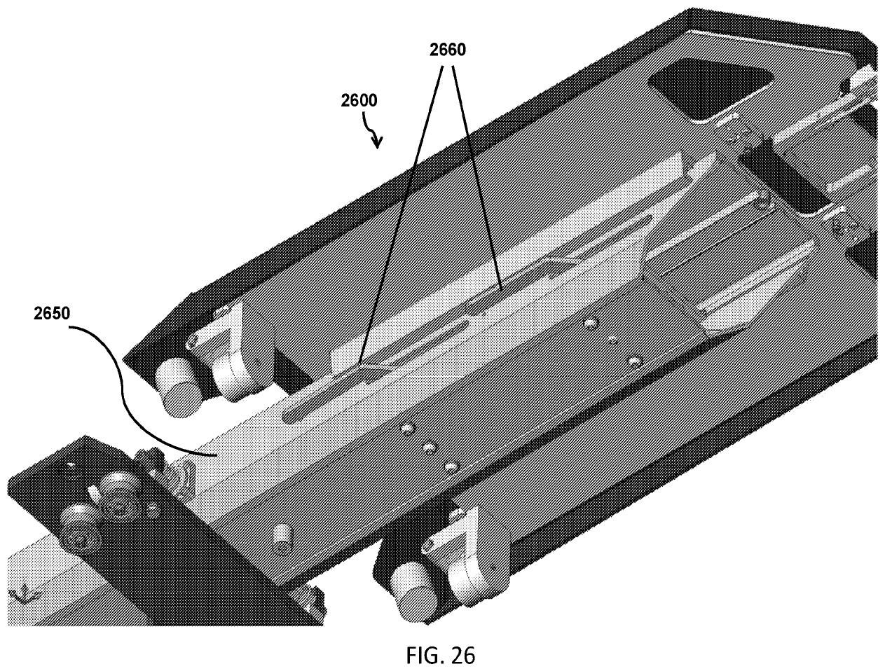

FIG. 26 shows a lower side feature 2660 of an exemplary pallet assembly 2600 supported by an arm 2650. The side features may relate to unlocking and/or locking a pallet assembly position relative to the arm. For instance, the pallet assembly may slide relative to the length of the arm and the side features may aid in locking or unlocking the pallet assembly position in place. The side features may relate to locking a pallet assembly to the arm, or unlocking the pallet assembly to the arm to remove the pallet assembly and swap in a different pallet assembly.

A garment may be a shirt, which may include a neck tag area as described. Any description of a shirt may also apply to any other type of garment, such as pants, skirts, dresses, or undergarments. In some instances, garments may encompass accessories, such as bags, backpacks, belts, scarves, gloves, hats, or other items. For instance, the pallet assembly may allow for a garment, such as pants, skirts, or dresses, to be placed over a main print area, and a front part of the garment may be pulled down with aid of one or more positioning pins, to expose a back inner panel of the garment. Any description herein of a neck tag may apply to any other region where it may be desirable to print tags. For instance, tags may be printed on a back inner panel of a set of pants, skirts, dresses, undergarments or other types of garments. Optionally, tags may be printed on portions of accessories, such as inner panels or backpacks or bags, gloves, hats or portions of belts or scarves. Any description herein of a neck tag area may apply to the back inner panel of any type of garment. Similarly, any description herein of a neck print plate or neck tag print plate may apply to any type of print plate that may rotate relative to the clamshell and be used to push up or support the back inner panel of a garment upon which a tag may be printed.

The garment may be loaded and/or unloaded on a neck tag pallet assembly quickly. An operator may be able to load and/or unload a garment via the neck tag pallet assembly within less than or equal to 60 seconds, 45 seconds, 30 seconds, 25 seconds, 20 seconds, 15 seconds, 13 seconds, 12 seconds, 11 seconds, 10 seconds, 9 seconds, 8 seconds, 7 seconds, 6 seconds, 5 seconds, 4 seconds, 3 seconds, 2 seconds, 1 second, 0.5 second, or 0.1 second. Automated loading and/or unloading of the garment may occur within any timeframe, as provided herein.

As shown in FIGS. 1-6, the pallet containing printed fabric product 152, in some embodiments, may then return to operator station 110, completing the circuit around the illustratively oval loop. There, the final printed fabric garment can be removed from the pallet, and a new, untreated garment can be loaded, beginning the process loop again. Note that in certain embodiments, the operator may move the garment into a follow-on drying station in order to fully cure the printed image(s), if needed. Alternatively, the pallet may return the final printed garment to a position adjacent, and within reach of, the operator at the operator station. In addition, information regarding overall process conditions and status may be provided to the operator by control screen 160. Thus, as can be seen, the entire process can be managed by a single operator, linking the components of the printing apparatus together in a customizable and programmable manner (e.g., heat, dwell time, print passes, etc.).

In some instances, an operator may manually enter information via the control screen. For instance, image data may be accessed or provided via the control screen. Any description herein of image data may encompass an image printed on a main print area and/or an image printed on a neck tag area. A main print area may be on a front, back, sleeve, or any other portion of a garment. Any description herein of an image may include pictures, characters (e.g., letters, numbers), symbols, code, or any other design that may be printed. In some instances, the operator may enter information, such as the dwell time, heat (e.g., temperatures, number of stations, etc.), print passes (e.g., number of print passes, arrangement of printing stations, pretreatment requirements), and so forth. The operator may base this information on the fabric and/or the image to be printed. In other embodiment, the operator may enter information about the garment fabric, and the system may automatically determine information, such as the dwell time, heat (e.g., temperatures, number of stations, etc.), print passes (e.g., number of print passes, arrangement of printing stations, pretreatment requirements), and so forth. The system may utilize algorithms that may determine printing details, such as dwell time, heat, print passes, etc. based on the fabric and/or the image to be printed. One or more computer systems may be utilized to help determine and/or control operation of the apparatus and stations. Such computer systems may include one or more processors that may execute one or more steps or calculations as described herein. Such computer systems may comprise one or more memory storage units that may comprise non-transitory computer readable media that may comprise code, logic or instructions for performing one or more steps or calculations as provided herein.

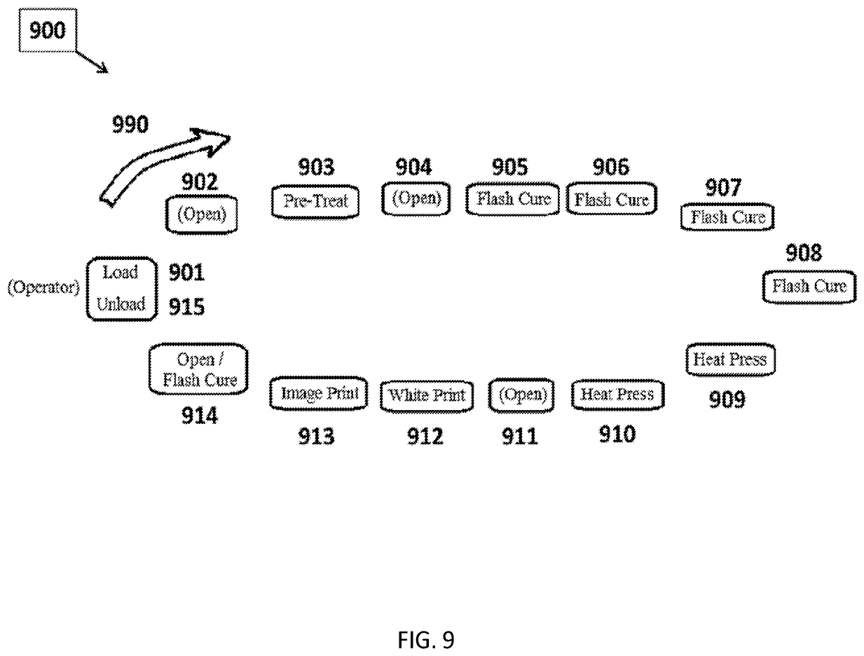

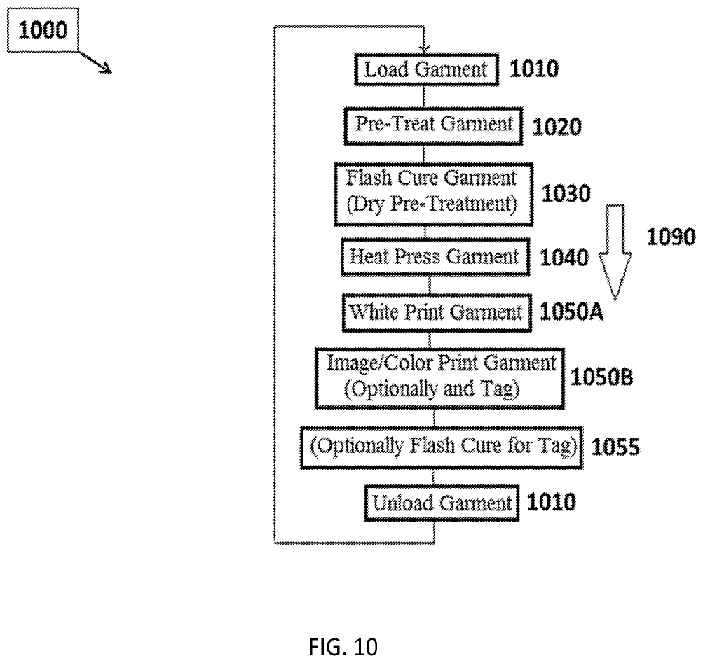

FIGS. 9-10 illustrate example procedures for high-turnaround, closed-loop, direct to garment printing in accordance with one or more embodiments described herein. For example, the steps shown may be configured for operation on the printing system described above, and controlled by a computing system which may perform the procedures by executing stored instructions.

For example, FIG. 9 illustrates general procedural steps for the illustrative system described above, with a plurality of sequential stations (such as multiple flash cure stations, and so on) at which a substrate stops for a predetermined dwell time. In particular, as shown, procedure 900 begins at operator station 901 at which an operator loads a fabric substrate onto a pallet. The loaded pallet may then move in direction 990 to first open station 902 and subsequently to pretreatment station 903 at which a portion of the printable surface of the fabric substrate may be treated, as described above. Open stations/positions may be desirable based on the distance between adjacent pallets and the relative locations of each station. After pretreatment, the pallet may then move through second open station 904 and subsequently through a series of heating stations, including flash cure stations 905-908 and heat press stations 909-910 during which the pretreated substrate surface may be dried and pressed, readied for printing. After passing through third open station 911, the pallet may then move through printing stations 912 and 913 for white and color image printing respectively. The resulting printed product may then pass through station 914, which may be an open position or a flash cure, as desired. Procedure 900 then ends at operator station 915, where the printed fabric product is unloaded. As shown, this is the same operator station where procedure 900 began.

Alternatively, FIG. 10 illustrates a more generic view, where an exact number of stations is not specifically shown, demonstrating the generalized configurability of the system described herein. As shown, procedure 1000 proceeds in direction 1090 includes operator station 1010 at which a garment may be loaded, pretreatment station 1020 to pretreat at least a portion of the area to be printed on the garment, heating stations 1030 and 1040 to flash dry and optionally heat press the pretreated garment (respectively), and printing stations 1050A and 1050B to print the image white and color ink on the pretreated portion of the garment. Optionally, at the printing station, a tag for the garment (e.g., a shirt tag) can also be printed, which can subsequently be dried at flash cure station 1055. Finally, the printed garment product may be unloaded at operator station 1010, and the process may begin again. Alternatively, in some embodiments, unloading may occur at a different operator station substantially adjacent to the station used for loading.

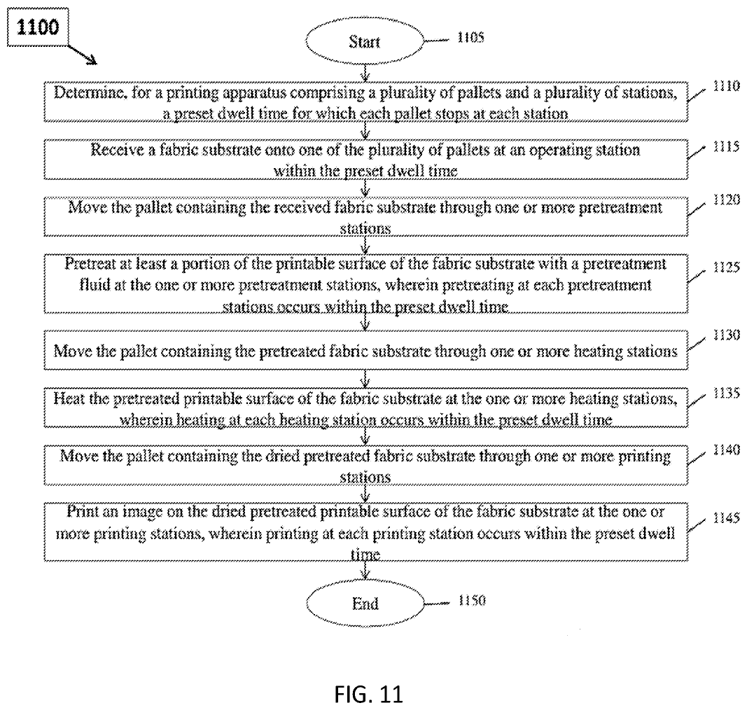

FIG. 11 illustrates an example simplified procedure for direct-to-garment printing, in accordance with one or more embodiments described herein. For example, a non-generic, specifically configured device (e.g., a controller) may perform procedure 1100 by executing stored instructions. The procedure 1100 may start at step 1105, and continues to step 1110, where, as described in greater detail above, a preset dwell time is determined for a printing apparatus having a plurality of pallets that are configured to secure a fabric substrate having a printable surface and that stop at a plurality of stations positioned along a closed-loop path of the printing apparatus. The fabric substrate (e.g., a garment, such as a tee shirt or sweatshirt) is secured in the pallet to provide access to the printable surface of the substrate upon which a chosen image is to be printed. Each pallet stops at each of the stations for the preset dwell time. The dwell time may be determined based on a rate-limiting step of the process (e.g., the station requiring the most time for the fabric substrate operation) or may be determined based on which step requires more time and cannot be repeated in subsequent stations. In some embodiments, the dwell time may be pre-established/preset based on the time needed to print the chosen image on the fabric substrate. In some instances, the dwell time may be calculated based on one or more parameters, such as chosen image, fabric type, color or type of ink to be used, pretreatment requirements, top coat requirements, available heaters or other stations. In some instances, the presence and/or identity of the stations may be automatically recognized and dwell time calculations may be updated as a result. Similarly, the chosen image and/or fabric may be automatically conveyed or manually inputted, and the dwell time calculations may be automatically updated.

At step 1115, the fabric substrate may be received on one of the plurality of pallets at an operator station within the preset dwell time (thus loading the fabric substrate at the operator station, such as by an operator). As described in greater detail above, loading and optionally further securing of the fabric substrate occurs within the determined preset dwell time in order to provide access to the printable surface of the fabric substrate. In some embodiments, this station may be the only manned station of the printing apparatus.

At step 1120, the pallet containing the received fabric substrate may move (e.g. sequentially) through one or more pretreatment stations. For example, as described in greater detail above, the loaded pallet may pass from the operator station to a pretreatment station comprising a nozzle jet printer configured to print a pretreatment solution. The pretreatment solution may incorporate any type of pretreatment solution, which may include an acidic pretreatment solution or a different type of pretreatment solution. Further details relating to printing the pretreatment solution are provided elsewhere herein. Intervening open stations may also be included as needed, depending on the position of the pretreatment station and the distance between pallets.

At step 1125, as described in greater detail above, at least a portion of the printable surface of the fabric substrate may be pretreated with a pretreatment fluid at one or more of the pretreatment station, resulting in a fabric substrate having a pretreated printable surface. In some embodiments, pretreatment may occur in a single pass, although multiple passes may be needed, depending on the size of the printable area and the type of fabric. However, as described above, pretreating occurs at each of the pretreatment stations within the preset dwell time. If additional time is needed, an additional pretreatment station may be included.

At step 1130, the pallet containing the fabric substrate having the pretreated printable surface may move (e.g. sequentially) through one or more heating stations. As described in greater detail above, the number of heating stations can vary, and, in some embodiments, 2 to 5 heating stations may be used, each programmed to heat at the same or different temperature and/or rate. In particular, a certain number of heating stations may be configured, where the certain number is selected based on the amount of time needed to dry the pretreated surface and/or the chosen drying temperature, while only drying at any one heating station within the preset dwell time, as described above.

At step 1135, in some embodiments, the pretreated printable surface of the fabric substrate may be heated at the one or more heating stations, resulting in a fabric substrate having a dried pretreated printable surface. As described in greater detail above, heating at each of the heating stations occurs within the preset dwell time. The heating stations may include various types of heaters, including, for example, infrared heaters. Also, optionally, one or more of the heating stations may comprise a heat press to both heat and smooth the pretreated surface.

At step 1140, as described in greater detail above, the pallet containing the fabric substrate having the dried pretreated printable substrate may move (e.g., sequentially) through one or more printing stations. In some embodiments, multiple printing stations may be used, such as to provide a white printed image first and a color printed image on or with the white image.

At step 1145, the chosen image is printed on the dried pretreated printable surface of the fabric substrate at one or more printing stations to form a printed fabric product. In some embodiments, at least one of the printing stations comprises an inkjet printer. For example, white inkjet ink may be printed onto the fabric substrate surface followed by printing of color inkjet ink, to form the chosen image. Thus, each of the one or more printing stations may print a respective portion of the image. The print heads may be coupled to reduce mechanical complexity within the print stations. However, as described in greater detail above, printing occurs at each of the printing stations within the preset dwell time. The printed fabric product may then be unloaded at the operator station. Optionally, the printed image may be dried, such as in a heat press, prior to unloading. Procedure 1100 then ends at step 1150.

It should be noted that certain steps within procedures 900, 1000, and 1100 may be optional as described above, and the steps shown in FIGS. 9-11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 900, 1000, and 1100 are described separately, certain steps from each procedure may be incorporated into each other procedure, and the procedures are not meant to be mutually exclusive.

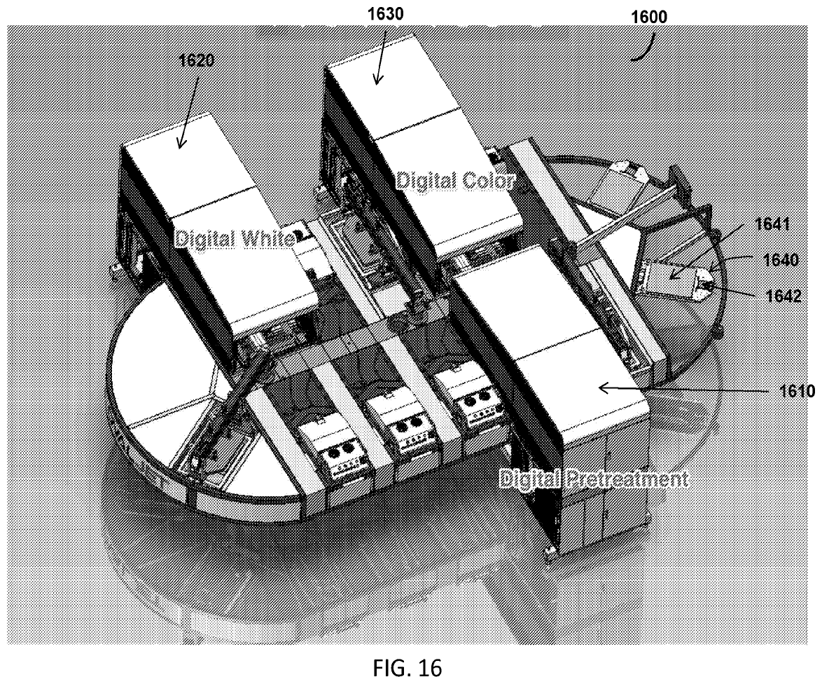

FIG. 16 shows an example of an apparatus for closed-loop, direct to garment printing 1600, including at least one digital pretreatment station 1610, and at least one print station 1620, 1630. One or more pallets 1640 may traverse the closed-loop, direct to garment printing apparatus. Optionally, the pallets may be neck tag pallets that may include an exposed main print area 1641 and neck tag area 1641, which may be at the same level. Alternatively, any other pallet configuration may be used.

As described elsewhere herein, nozzle jet printers may be used at the one or more digital pretreatment stations and/or the one or more print stations. In some embodiments a separate digital white print station 1620 and digital color print station 1630 may be provided. A heating station may or may not be provided between the digital white and digital color printing station. Alternatively, both the white printing and the color printing may be provided at a single station.

The nozzle jet printer of the pretreatment station may operate similarly to the printers of the white and/or color printing station. Any description herein of a nozzle jet printer may apply to any type of printer that may be utilized to print white and/or color images. For instance, a spray nozzle may be used. In other instances, a drop-on-demand (DOD) print head may be used. For example, valve jet print heads, such as REA JET DOD 2.0 may be used, or may share similar characteristics. In some instances, a continuous inkjet (CIJ) system may be used. The nozzle jet printer may print digital images on the garment. The nozzle jet printer may include a single nozzle, a row or column or nozzles, or an array of nozzles that may digitally print on the underlying garment. In some instances, 1 or more, 2 or more, 4 or more, 8 or more, 16 or more, 32 or more, 64 or more, or any number of nozzles may be provided. The nozzles may be used to print pretreatment solution in the same pattern as the image. In some instances, a single pass of a carriage head may be sufficient to print the pre-treatment solution. Alternatively, multiple passes may be provided. This may advantageously minimize waste of pretreatment solution, and/or ensure that fabric without the image remains as solution-free as possible. Data about the image to be printed may be provided to the pretreatment station, which may allow the nozzle jet printer to be controlled to print only the same pattern as the image.

In some instances, one or more printers, (e.g., two or more valve jet printers) may be used to print pretreatment in the same “dot for dot” pattern as the image. This may allow the printing apparatus to use a pretreatment liquid that has a higher concentration of binder, since the process is no longer concerned with defects that may be associated with spraying an entire surface of substrate (e.g., staining, dye migration, color shift).

The dot size and/or dot pressure may be controllable. For instance, one or more XML, commands may be provided that may indicate desired dot size and/or pressure. This may allow the systems and methods to lay down variable drop volume for different substrate thicknesses or other material properties. The result may be to take a slightly viscous/resinous material and coat fibers until a point of saturation is reached. Then the material may be cured to create a new ink-receptive ‘film’ that sits on top of the substrate. When printing on the film, there is less concern about the chemical properties of the substrate, since a new thin and stable substrate has been created to be printed upon, by undergoing the pretreatment process.

A nozzle jet printer for the pretreatment station may optionally operate at any desired degree of resolution. For instance, the pretreatment solution may be laid down with at least a 60 dpi, 90 dpi, 120 dpi, 150 dpi, 200 dpi, 300 dpi, 400 dpi, 600 dpi, 900 dpi, 1200 dpi, 1800 dpi, 2400 dpi, 3000 dpi, or greater, resolution.

When the pallet and garment subsequently travel to a printing station, the images may be printed directly over the pattern laid down at the pretreatment station. The jet printers at subsequent printing stations may receive data about the image to be printed. In some instances, the white ink may be laid down first, before adding the color. The printers at the print stations may operate similarly to the printer at the pretreatment station. They may operate with the same degree of resolution and/or speed. Alternatively, there may be one or more different characteristics between the pretreatment printer and the print station printers.

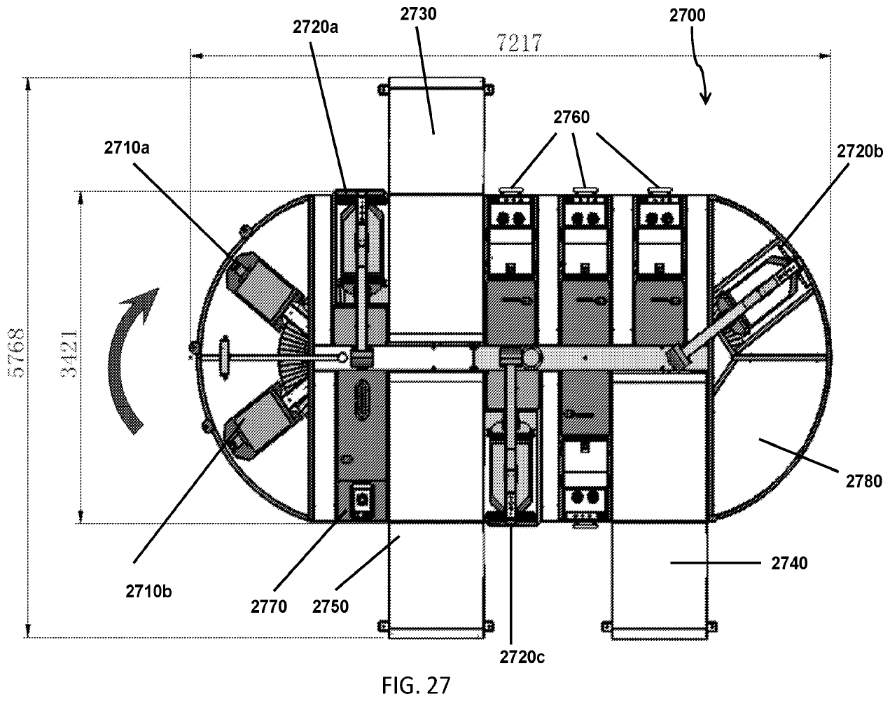

FIG. 27 shows a top view of a closed-loop, direct to garment printing apparatus 2700. Optionally, one, two or more loading/unloading stations 2710a, 2710b may be provided. In some instances, a single operator configuration may be provided that may allow for a single individual load and/or unload the garments from the printing apparatus. Optionally, a dual operator configuration may be provided that may allow for two individuals to simultaneously load and/or unload the garments from the printing apparatus. Any type of multi-operator configuration may be provided that may allow for any plurality of individuals to load and/or unload the garments from the printing apparatus (e.g., two, three, four, five, six or more operators may load and/or unload the garments from the printing apparatus in parallel). Any of the operators of the printing apparatus need not move from their location while loading and/or unloading the garments. The printing apparatus may be controlled sot that the pallet assemblies and/or garments arrive at the appropriate station for each operator correctly. In some instances, a particular printing apparatus may be able to switch between single operator and multi-operator (e.g., dual operator) modes.

A fixed vision reader may be provided to scan an image, such as a barcode/QR code, as an operator is loading a garment. A barcode scanner, such as 1D, or 2D barcode scanner may be used. Any type of image capture device may be used to capture an image of a production barcode. In alternative embodiments, the image may include symbols, characters, strings, or any other visually discernible or recognizable features. An operator may no longer need to pre-scan any jobs into the production queue. The image may be recognized and any necessary configurations or processes for the printer apparatus may be automatically updated.

A printing apparatus may accept XML data that may be sent in conjunction with a print file. The data may manipulate parameters in one or more components of the printing apparatus. Examples of parameters may include, but are not limited to, pretreatment drop size and drop volume, flash dryer temperature/duration, heat press temperature/duration, head height for white and color cabinets, and so forth. The XML data may affect dwell time of the pallet assembly at one or more stations. This may provide a user with an ability to apply unlimited “setups” dynamically for each individual image/garment scenario.

One or more heat press stations 2720a, 2720b, 2720c may be provided for the printing apparatus. A heat press may be designed to flatten fibers of a substrate in one or more portions of the process. The heat press may heat and/or press down a garment to prepare the garment for a desirable treatment.

For instance, a heat press station 2720a may be provided before pretreatment. The heat press station may be adjacent to and/or preceding a pretreatment station 2730. The heat press may create a paper-like surface for smooth adhesion and lay down of pretreatment liquid.

A heat press station 2720b may be provided before printing with white ink. The heat press station may be adjacent to and/or preceding a white printing station 2740. Some textile fibers may pop up after curing. This may be mitigated by adding the heat press after curing the pretreat and before printing with white ink.

Optionally, a heat press station 2720c may be provided before printing with color. The heat press station may be adjacent to and/or preceding a color printing station 2750. The heat press station may be provided after curing the white ink, and before applying the color ink. This may help eliminate or reduce any of the fibers that have re-emerged after curing the white ink.

It may be desirable to provide a heat press station prior to printing on a garment (e.g., printing pretreatment solution, printing with white ink, printing with color ink). The heat press station may be provided immediately prior to the respective printing station. This may aid in providing a flat smooth surface to optimize printing conditions.

Heat press temperature and duration may be controlled via programmable logic controller (PLC) and PLC presets may be able to be toggled via XML commands. One or more preset configuration on the PLC may be provided.

One or more flash dryers 2760, 2770 may be provided. Infrared flash curing technology may be utilized. The flash dryers may be individually PLC-driven. The temperature and/or duration of each individual flash dryer may be controlled dynamically per print. The flash temperature and/or duration may be controlled via PLC and PLC presets, which may be able to be toggled via XML commands.

In some embodiments, a plurality of flash dryers may be provided between the pretreatment station and the white ink printing station. The plurality of flash dryers may be provided before a heat press station prior to the white ink printing station. Optionally, one, two, three, four or more flash dryers may be provided.

In some instances, one or more flash dryers 2770 may be provided after the color ink printing station. The one or more flash dryers may be provided before a garment is unloaded. The flash dryer may optionally be provided for drying the neck tag region of the substrate. The flash dryer may dry both the neck tag region and a main print region of the substrate.

Print head protection mechanisms 2780 may be provided. A plurality of height and temperature sensors may be mounted above the print head protection region. The sensors may be arranged in any manner, such as individual sensors, rows of sensors, columns of sensors, arrays of sensors, or any other configuration. The print head protection region may be provided before a white ink printing station. The print head protection region may be provided after, or before a heat press station that precedes the white ink printing station.

The sensors may be used to detect if there are any wrinkles in the substrate (e.g., garment fabric), or if the substrate is too warm for the print heads. If any wrinkles are present, they may damage the print heads in a form of a ‘heat strike’. Too much heat can also damage print heads. If the sensors detect any potential issues (e.g., wrinkles, heat), then the process may come to a halt to allow an operator to fix the issue. In some instances, if the sensors detect a condition that may be fixed without manual intervention (e.g., heat), then the dwell times may be adjusted to allow for desirable conditions to take place.

A white ink printing station 2740 and a color printing station 2750 may be provided. The white print heads and color print heads may be separated into separate digital printing stations. This may be desirable to produce a higher quality result. For instance, a combination of heat, time, and pressure between the white and color layers may produce a higher quality result on a more consistent basis. The white layer may be cured and optionally, pressure may be added to give a smooth hand feel to the final print. This may be obtained via the curing and heat press between the white ink printing station and the color ink printing station.

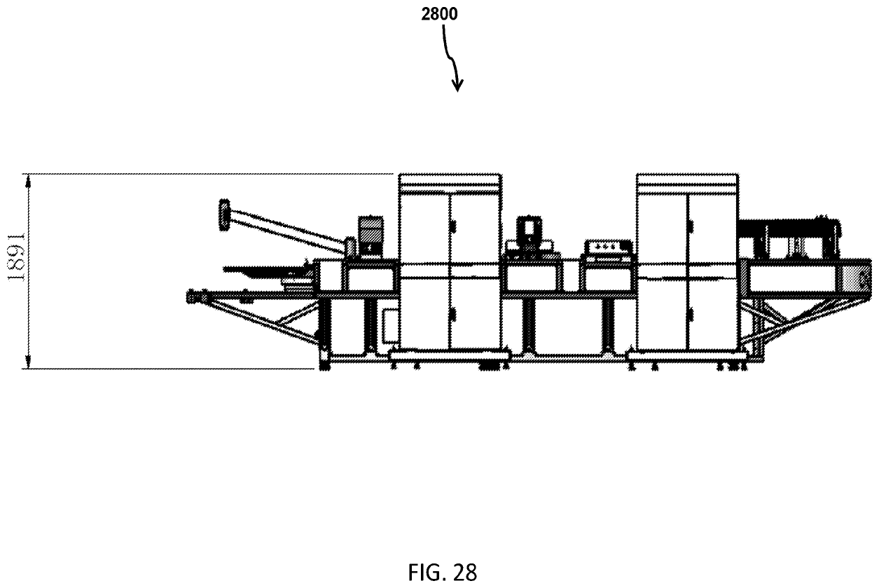

FIG. 28 shows a side view of a closed-loop, direct to garment printing apparatus 2800.

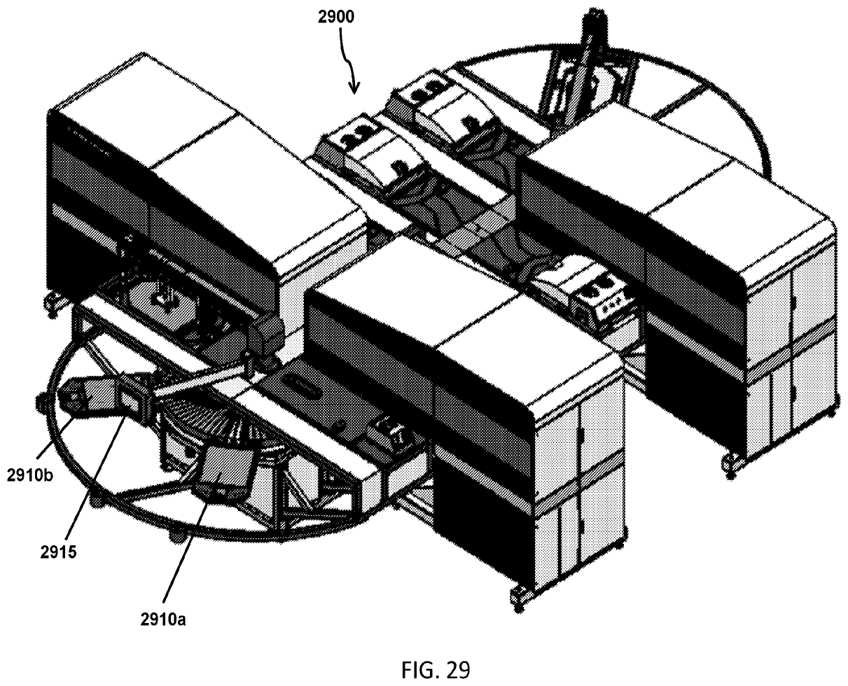

FIG. 29 shows a perspective view of a closed-loop, direct to garment printing apparatus 2900. As previously described, multiple operator stations 2910a, 2910b may optionally be provided. The operators may share a control screen 2915, or each operator may have their own control screen. The control screen may allow for one or more commands to be provided, which may affect operation of the printing assembly.

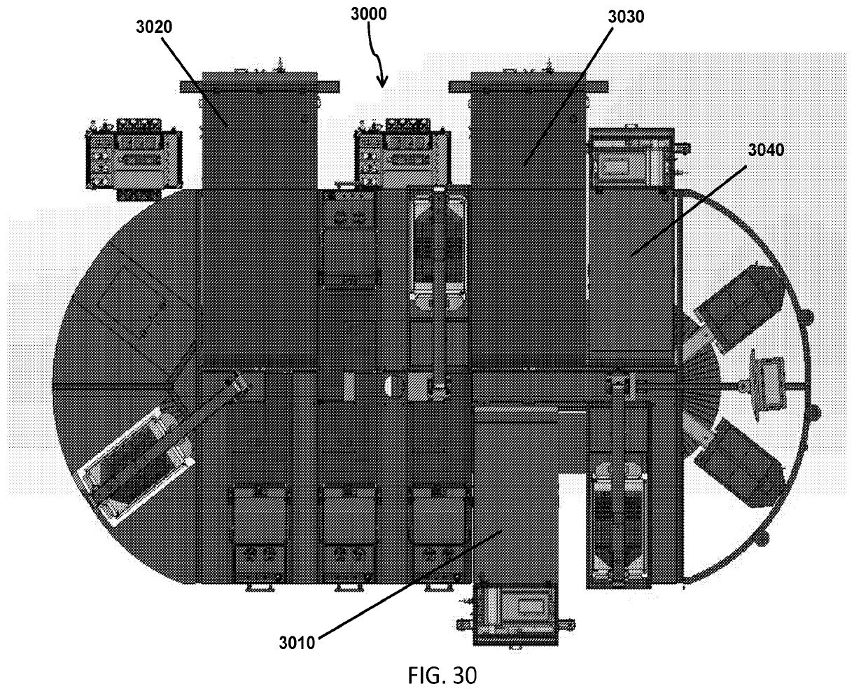

FIG. 30 shows an example of a closed-loop, direct to garment printing apparatus 3000 that employs a top coat printing station 3040. As previously described, a printing apparatus may include one or more pretreatment stations 3010 where pretreatment solution may be applied to a garment traversing printing apparatus. A printing apparatus may include one or more printing stations, such as a white ink printing station 3020 and a color ink printing station 3030. The white ink printing station may provide white ink to the garment before the color ink printing station applies color ink to the garment. The garment may travel from the pretreatment station to the one or more printing stations. The garment may travel from the pretreatment station to the white ink printing station, to the color ink printing station. Any of these printing stations may employ digital printing techniques and apparatus, as described elsewhere herein. One or more heating, drying, and/or curing stations may be provided as described elsewhere herein. Any characteristics or features of a printing apparatus as described elsewhere herein may be applied.

After the one or more printing stations (e.g., after the color ink printing station), a top coat printing station 3040 may be provided. The top coat printing station may allow a top coat solution to be applied to the garment. The top coat solution may be applied on top of one or more ink layers. For instance, the top coat solution may be applied over a white ink layer and/or color ink layer. The top coat printing station may employ digital printing techniques, such as those described elsewhere herein. The top coat printing station may have the same printing mechanisms as the pretreatment station, or the white or color ink printing stations.

As described elsewhere herein, nozzle jet printers may be used at the one or more digital top coat printing stations, pretreatment stations, and/or the one or more print stations. The nozzle jet printer of the top coat printing station may operate similarly to the printers of the pretreatment station, and/or the white and/or color printing station. Any description herein of a nozzle jet printer may apply to any type of printer that may be utilized to print white and/or color images. For instance, a spray nozzle may be used. In other instances, a drop-on-demand (DOD) print head may be used. For example, valve jet print heads, such as REA JET DOD 2.0 may be used, or may share similar characteristics. In some instances, a continuous inkjet (CIJ) system may be used. The nozzle jet printer may print digital images on the garment. The nozzle jet printer may include a single nozzle, a row or column or nozzles, or an array of nozzles that may digitally print on the underlying garment. In some instances, 1 or more, 2 or more, 4 or more, 8 or more, 16 or more, 32 or more, 64 or more, or any number of nozzles may be provided. The nozzles may be used to print a top coat solution in the same pattern as the image. In some instances, a single pass of a carriage head may be sufficient to print the top coat solution. Alternatively, multiple passes may be provided. This may advantageously minimize waste of top coat solution, and/or ensure that fabric without the image remains as solution-free as possible. Data about the image to be printed may be provided to the top coat station, which may allow the nozzle jet printer to be controlled to print only the same pattern as the image.

In some instances, one or more printers, (e.g., two or more valve jet printers) may be used to print top coat solution in the same “dot for dot” pattern as the image. This may allow the printing apparatus to use a top coat liquid that has a higher concentration of binder, since the process is no longer concerned with defects that may be associated with spraying an entire surface of substrate (e.g., staining, dye migration, color shift).

The dot size and/or dot pressure may be controllable. For instance, one or more XML, commands may be provided that may indicate desired dot size and/or pressure. This may allow the systems and methods to lay down variable drop volume for different substrate thicknesses or other material properties.

A nozzle jet printer for the top coat station may optionally operate at any desired degree of resolution. For instance, the top coat solution may be laid down with at least a 60 dpi, 90 dpi, 120 dpi, 150 dpi, 200 dpi, 300 dpi, 400 dpi, 600 dpi, 900 dpi, 1200 dpi, 1800 dpi, 2400 dpi, 3000 dpi, or greater, resolution.

The top coat printing station may print a top coat solution over the garment. The top coat printing station may print the top coat solution over a desired section of the garment. The top coat printing station may print the top coat solution over (or only over) a white and/or color ink image on the garment. For instance, the top coat printing may station may print the top coat solution over an image in a main print area or any design printed in a neck tag area.

In some embodiments, the top coat solution may be different from a pretreatment solution and/or inks (e.g., white ink or color ink). The top coat solution may be the same as the pretreatment solution and/or inks or share any characteristics of the pretreatment solution and/or inks. In some embodiments, the top coat solution may be a water-based resin system. The top coat solution may comprise a chemical that may color a printed image on the garment and seal the image in an enclosed layer of pretreatment on the bottom and top coat on top.

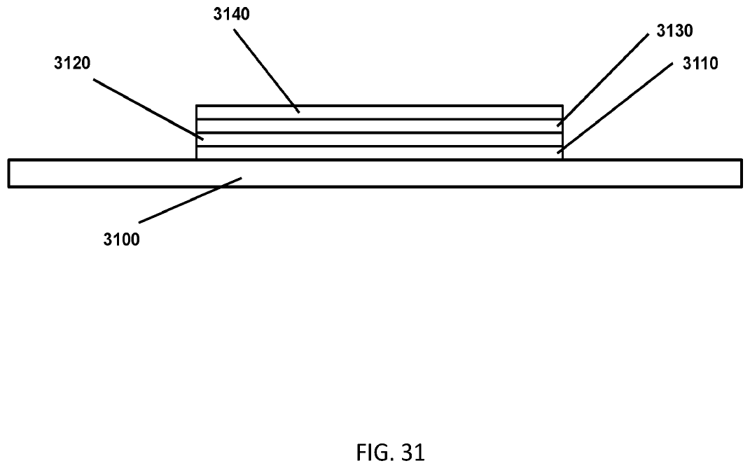

FIG. 31 shows an example of a garment with one or more layers of solution applied thereon. A garment 3100 may be any type of garment or fabric substrate as described elsewhere herein. A layer of pretreatment solution 3110 may be applied on the garment. One or more ink layers, such as one or more white ink layers 3120 and/or one or more color ink layers 3130 may be applied. The top coat solution 3140 may be provided above the one or more ink layers. The image formed by the ink layers may be sealed and/or sandwiched between the pretreatment layer and the top coat layer. This may allowed for improved preservation of the image formed by the one or more ink layers. This may provide greater durability to the image. This will allow the garment and image thereon to pass rigorous industry wash test standards. In some instances, this may be particularly advantageous for garments with at least some polyester. For instance, 100% polyester garments may derive benefit from the top coat applied over the image. Improved adhesion and wash durability may be provided through use of the top coat. For instance, a garment may preserve the image at a high quality, even after being subjected to a greater number of wash cycles, with aid of the top coat. Less fading or cracking may occur over time.

In some embodiments, the garment may traverse the printing apparatus with aid of a pallet assembly as described elsewhere herein. The garment may travel between the various stations described. For instance, a garment may travel between a pretreatment station, one or more printing stations (e.g., white ink printing station, color ink printing station), and/or one or more top coat printing stations. For instance, a garment may travel between a printing station, such as a color ink printing station, and the one or more top coat printing stations. A top coat printing station may be provided separately from a printing station, such as a color ink printing station. This may be advantageous in providing desired timing of the various printing steps. For instance, a garment may remain at a particular station for a preset dwell time. This may allow the garment to have color ink to be applied, and then remain at the color ink station for a dwell time, before moving on to the top coat printing station, and then remaining at the top coat printing station for a particular dwell time. This may allow for overall faster turnaround by the printing apparatus while allowing for a desired amount of resting and/or curing by the ink image before applying the top coat solution. For instance, this may allow a top coat to be applied to a first garment, while simultaneously, white or color ink is being applied to a second garment. This may also advantageously allow for intermediary stations to be provided between the ink printing and the top coat solution application if desired (e.g., if intermediary heating, drying and/or curing is desired).

Furthermore, by providing the top coat solution as a separate station from an ink printing station, the ink printing stations are permitted to have a full range of colors to print without sacrificing any color to accommodate the top coat solution. For instance, 4 or more, 6 or more, 8 or more, 10 or more, 12 or more, 16 or more, or 20 or more colors may be applied at the color printing station. The top coat solution may be applied separately.

Each station may have its own configuration. In some embodiments, one or more stations may have a housing that may partially or completely enclose one or more components of the station. For example, a pretreatment station may comprise a housing that may partially or completely enclose one or more pretreatment solution print nozzles. The housing may partially or completely enclose a printable area on the garment to which the pretreatment solution may be applied. A housing of a pretreatment station may not enclose an ink print nozzle (e.g., white ink print nozzle, color ink print nozzle), and/or top coat solution print nozzle. A white ink printing station may comprise a housing that may partially or completely enclose one or more white ink print nozzles. The housing may partially or completely enclose a printable area on the garment to which the white ink may be applied. A housing of a white ink printing station may not enclose a pretreatment solution print nozzle, color ink print nozzle, and/or top coat solution print nozzle. A color ink printing station may comprise a housing that may partially or completely enclose one or more color ink print nozzles. The housing may partially or completely enclose a printable area on the garment to which the color ink may be applied. A housing of a color ink printing station may not enclose a pretreatment solution print nozzle, white ink print nozzle, and/or top coat solution print nozzle. In some embodiments, a printing station may comprise a housing that may partially or completely enclose one or more white ink print nozzles and color ink print nozzles. The housing may partially or completely enclose a printable area on the garment to which the white ink and color ink may be applied. A housing of an ink printing station may not enclose a pretreatment solution print nozzle, and/or top coat solution print nozzle. A top coat printing station may comprise a housing that may partially or completely enclose one or more top coat print nozzles. The housing may partially or completely enclose a printable area on the garment to which the top coat solution may be applied. A housing of a top coat printing station may not enclose a pretreatment solution print nozzle, and/or an ink print nozzle (e.g., white ink print nozzle, color ink print nozzle).

Any housing provided herein may include one or more transparent, translucent, or opaque portions. In some instances, a transparent or translucent portion may allow an individual to view the progress of printing the pretreatment solution, inks, and/or top coat. The housing may include a region that may be opened by an operator. One or more portion of a housing may be hinged so that an operator may open the housing if needed to access one or more components or objects within the housing. The pallet assembly may be capable of entering and/or exiting the housing without requiring interference by an operator. The pallet assembly may be capable of entering and/or exiting under a wall of a housing or through a slit in the housing.

The top coat printing station may be provided anywhere along the printing apparatus. The top coat printing station may be located after any of the other stations described elsewhere herein. The top coat printing station may be provided after a printing station, such as the color ink printing station. The top coat printing station may be provided immediately after a printing station, such as the color ink printing station. Alternatively, one or more intermediary stations (e.g., heating, drying, curing stations) may be provided between the printing station and the top coat printing station. The top coat printing station may be provided in addition to the various stations described, or may be provided instead of any of the various stations described. In one example, the top coat printing station may replace a dryer station, such as a neck tag flash dryer station.

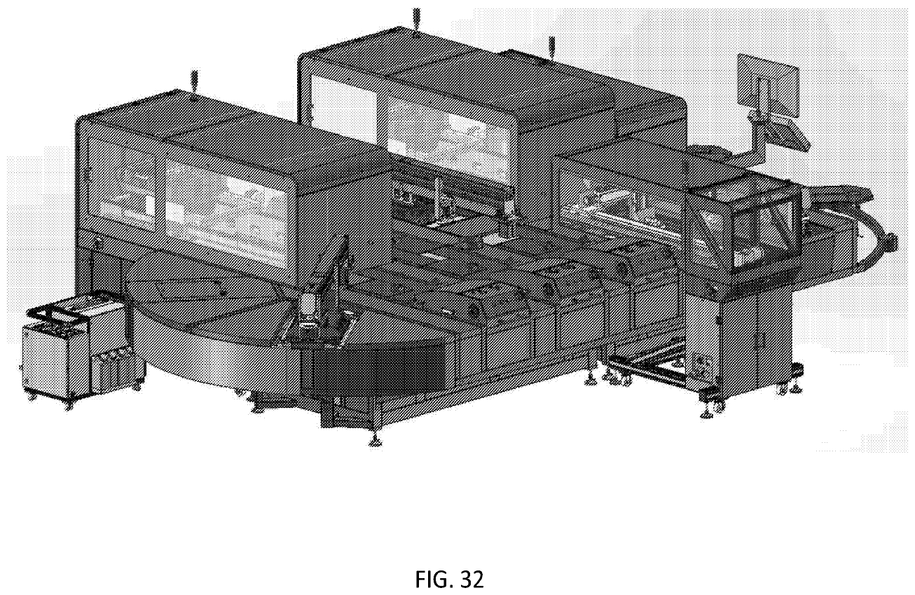

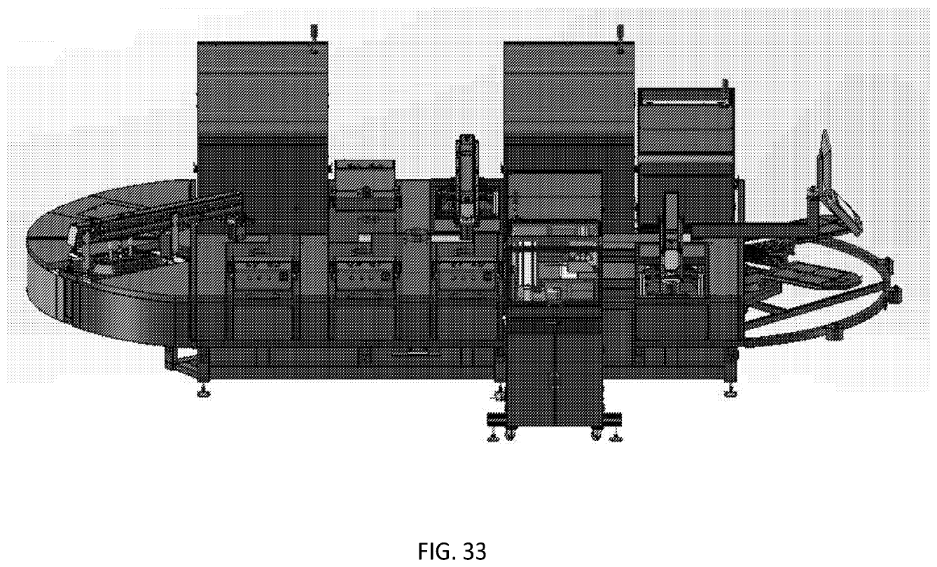

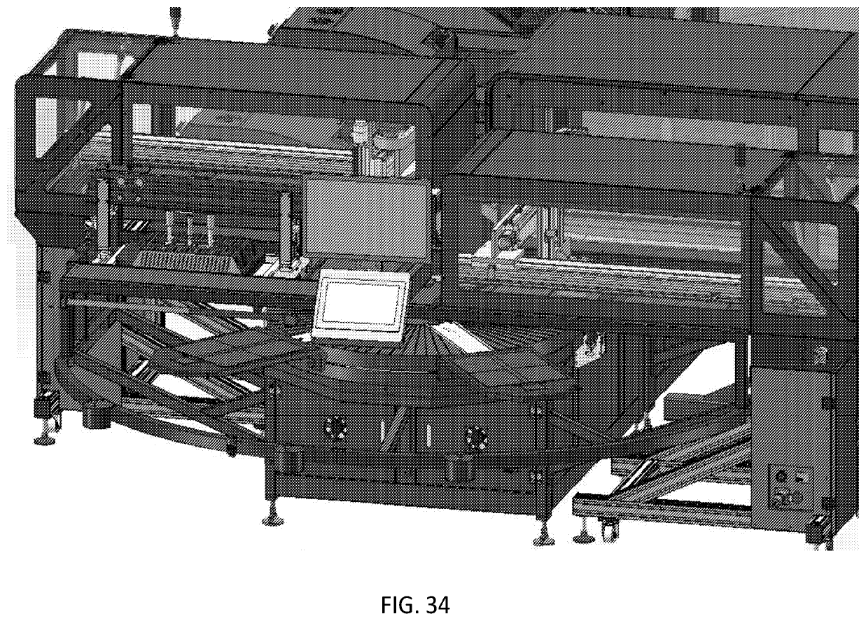

FIGS. 32-34 show additional views of a closed-loop, direct to garment printing apparatus that employs a top coat printing station. Such views are provided as exemplary illustrations.

Advantageously, the techniques herein provide for high-turnaround, closed-loop, direct to garment printing, producing a high quality printed fabric product in a short period of time. In particular, the techniques herein are faster at producing quality printed garments at scale than current systems (e.g., 300 per hour or more), while still remaining high quality and high resolution, yet only requiring a single operator for use, from start (inserting an untreated garment) to finish (removing the printed product) in a “wet-to-dry-to-wet” single-system serial process. Furthermore, the image resolution provided by the techniques herein may be better than conventional wet-on-wet systems, since there is no mixing or smearing of the inks with the pretreatment solution. Other advantages, such as contemporaneous tag printing, reduced pretreatment areas (e.g., pretreating only where needed based on the selected image), automatic system control (e.g., algorithms to adjust phases of the process based on various inputs and correlated functionalities), and many others may also be attained according to the techniques described above.

While there have been shown and described illustrative embodiments that provide for high-turnaround, closed-loop, direct to garment printing, it is to be understood that various other adaptations and modifications may be made within the scope of the embodiments herein. For example, the embodiments may be used in a variety of types of fabric printing, such as canvas, towels, sheets, pillows, and many other fabric types and functions, and the techniques herein need not be limited to the illustrative garment implementations as shown. Furthermore, while the embodiments may have been demonstrated with respect to certain configurations, physical orientations, or system component form factors, other configurations may be conceived by those skilled in the art that would remain within the contemplated subject matter of the description above. In particular, the foregoing description has been directed to specific embodiments. It will be apparent, however, that other variations and modifications may be made to the described embodiments, with the attainment of some or all of their advantages.

Notably, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. For instance, the apparatus and/or the stations may comprise one or more processors that may execute one or more steps and/or send control signals to one or more components of the apparatus and/or stations. The apparatus and/or stations may comprise a memory storage unit, which may comprise non-transitory computer readable medium including the code, logic or instructions to for any of the steps described.

Additionally, the certain aspects of the system described herein may be performed by (or in conjunction with) a computing device having one or more network interfaces (e.g., wired, wireless, etc.), at least one processor, and a memory. The network interface(s) may contain the mechanical, electrical, and signaling circuitry for communicating data to computer networks (e.g., local area networks, the Internet, etc.). The memory comprises a plurality of storage locations that are addressable by the processor for storing software programs and data structures associated with the embodiments described herein. The processor may comprise hardware elements or hardware logic adapted to execute the software programs and manipulate the data structures. An operating system, portions of which is typically resident in memory and executed by the processor, functionally organizes the device by, among other things, invoking operations in support of software processes and/or services executing on the device. These software processes and/or services may illustratively include one or more control processes, user interface processes, system maintenance processes, point of sale collaboration processes, and so on, for performing one or more aspects of the techniques as described herein.

Illustratively, the techniques described herein may be performed by hardware, software, and/or firmware (such as in accordance with the various processes of a computing device local to or remote from the system), which may contain computer executable instructions executed by processors to perform functions relating to the techniques described herein. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes may be operational separately, or on specific devices, those skilled in the art will appreciate that processes may be routines or modules within other processes, and that various processes may comprise functionality split amongst a plurality of different devices (e.g., client/server relationships).

Accordingly this description is to be taken only by way of example and not to otherwise limit the scope of the embodiments herein. Therefore, it is the object of the appended claims to cover all such variations and modifications as come within the true spirit and scope of the embodiments herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A pallet assembly for direct-to-garment printing, comprising:
a main print plate configured to accept a garment;
a clamshell comprising one or more open areas and configured to rotate relative to the main print plate between (1) an open position in which the garment may be loaded onto the main print plate or unloaded from the main print plate, and (2) a closed position that secures the garment to the main print plate; and
a neck print plate coupled to the clamshell and configured to rotate relative to the clamshell.

2. The assembly of claim 1, wherein the main print plate comprises, or is supported by a substrate that comprises, one or more positioning pins configured to secure a collar of the garment when the garment is loaded onto the main print plate.

3. The assembly of claim 1, wherein at least a portion of the main print plate is configured to be inserted into the garment when the garment is loaded onto the main print plate.

4. The assembly of claim 1, wherein clamshell is rotates relative to main print plate with aid of a hinge (1) supported by the main print plate, or (2) supported by a substrate that also supports the main print plate.

5. The assembly of claim 1, wherein the clamshell is an open frame such that the one or more open areas are large enough to expose a main print area on the front of the garment and a tag area on the neck of garment when the clamshell is in the closed position.

6. The assembly of claim 1, wherein the neck print plate is coupled to the clamshell with aid of a spring-loaded hinge.

7. The assembly of claim 6, wherein the neck print plate is biased by the spring to be substantially parallel to the clamshell in an upward position.

8. The assembly of claim 7, wherein the neck print plate is configured to be at substantially the same level as the main print plate when the neck print plate is at the upward position.

9. The assembly of claim 1, wherein the assembly is movable along a closed-loop printing apparatus that comprises a plurality of stations.

10. The assembly of claim 9, wherein the plurality of stations comprise at least one pretreatment station configured for pre-treating a main print area on the front of the garment and a tag area on the neck of the garment, at least one heating station configured for heating and drying a pretreated main print area and pretreated tag area, and at least one printing station configured for printing an image on a dried pretreated main print area and a dried pretreated tag area to form a printed garment.

11. The assembly of claim 10, wherein the at least one pretreatment station comprises one or more nozzles or one more drop-on-demand print heads configured to digitally print with a pretreatment solution on the garment in a same pattern as an image to be printed by the at least one printing station.

12. A method of direct-to-garment printing, said method comprising:
providing a pallet assembly comprising:
a main print plate configured to accept a garment;
a clamshell comprising an open area and configured to rotate relative to the main print plate between (1) an open position in which the garment may be loaded onto the main print plate or unloaded from the main print plate, and (2) a closed position that secures the garment to the main print plate; and
a neck print plate coupled to the clamshell and configured to rotate relative to the clamshell; and
loading a garment over the main print plate of the pallet assembly.

13. The method of claim 12, wherein at least a portion of the main print plate is inserted within the garment when the garment is secured over the main print plate.

14. The method of claim 12, wherein the clamshell is in the open position while the garment is secured over the main print plate.

15. The method of claim 14, wherein a collar of the garment is secured with aid of one or more positioning pins, thereby exposing a neck tag region of the garment.

16. The method of claim 14, further comprising pushing down the clamshell to the closed position after the garment is secured over the main print plate.

17. The method of claim 16, further comprising pulling the neck print plate into a down position while the clamshell is pushed down to the closed position.

18. The method of claim 17, wherein the neck print plate is substantially perpendicular to the clamshell when in the down position.

19. The method of claim 17, further comprising releasing the neck print plate after the clamshell is pushed down to the closed position, thereby allowing the neck print plate to rotate to an upward position.

20. The method of claim 19, wherein the neck print plate is substantially parallel to the clamshell when in the upward position.

21. The method of claim 19, wherein the neck print plate is substantially at the same level as the main print plate when the neck print plate is at the upward position.

22. The method of claim 21, wherein a back panel of the garment comprising a neck tag area is pushed upwards with the neck print plate to be at the same level as a top panel of the garment comprising a main print area.

23. The method of claim 19, further comprising allowing one or more print head carriages to move relative to the garment and print on a main print area and a neck tag area.

24. The method of claim 23, wherein the one or more print head carriages prints a pretreatment solution on the main print area and the neck tag area in a pattern that matches an image to be printed by at least one printing station.

25. The method of claim 23, wherein the one or more print head carriages prints an image on a pretreated area of the main print area and the neck tag area.

26. The method of claim 23, further comprising allowing the pallet assembly to move about a closed-loop printing apparatus that comprises a plurality of stations.

27. The method of claim 26, further comprising moving the pallet assembly to at least one heating station that allows the neck tag area and the main print area to be at least partially cured.

28. The method of claim 27, wherein the neck tag area is cured by turning on a neck tag flash.

29. The method of claim 27, further comprising unloading the garment from the pallet assembly by pulling the neck print plate downward while rotating the clamshell to the open position, and removing the garment from the main print plate.

30. A method for direct-to-garment printing, said method comprising:
applying, with aid of a color printing apparatus comprising one or more color print nozzles, color ink over the layer of white ink on a garment supported by a pallet assembly;
moving the pallet assembly with the garment supported thereon to a top coat printing apparatus; and
applying, with aid of the top coat printing apparatus comprising one or more top coat print nozzles, a top coat over the color ink applied to the garment, wherein the top coat comprises a solution that improves durability of the white ink and the color ink applied to the garment.

31. The method of claim 30 wherein the color printing apparatus comprises a first housing configured to at least partially enclose the one or more color print nozzles, and wherein the top coat printing apparatus comprises a second housing configured to at least partially enclose the one or more top coat nozzles without enclosing the one or more color print nozzles.

32. The method of claim 30, further comprising:
applying, prior to applying the color ink and with aid of a first printing apparatus comprising one or more white print nozzles, a layer of white ink on the garment supported by the pallet assembly; and
moving the pallet assembly, with the garment supported thereon, prior to applying the color ink, to the color printing apparatus.

33. The method of claim 30, wherein the pallet assembly remains within the color printing apparatus for a dwell time prior to moving to the top coat printing apparatus.
